(19) United States
(12) Patent Application Publication
(10) Pub. No.: US 2011/0047166 A1
(43) Pub. Date: Feb. 24, 2011

(54) SYSTEM AND METHODS OF RELATING TRADEMARKS AND PATENT DOCUMENTS

(75) Inventors: Tyron Stading, Austin, TX (US); Roji John, Austin, TX (US); Shu-Wai Chow, Austin, TX (US)

Correspondence Address: Polansky & Associates, P.L.L.C., 12117 Bee Caves Road, Suite 160, Austin, TX, 78738, US

(73) Assignee: Innography, Inc., Austin, TX (US)

(21) Appl. No.: 12/544,738

(22) Filed: Aug. 20, 2009

(51) Int. Cl. G06F 17/30

(52) U.S. Cl. 707/749; 707/E17.008; 707/E17.109

(57) ABSTRACT

In an embodiment, a computer-readable medium embodies instructions that, when executed by at least one processor, cause a computing system to perform operations including automatically defining one or more associations between a trademark record and a patent document and storing the one or more associations as mappings between trademarks and patent documents.

### FIELD

The present disclosure relates generally to a system and methods of relating trademarks and patent documents.

### BACKGROUND

The United States Patent and Trademark Office provides a trademark database, a patent database, and a patent publication database. Each of the databases is accessible through the Internet and is independently searchable to retrieve data related to trademarks, patents, and patent publications, respectively. However, it is currently not possible through the United States Patent and Trademark Office website to retrieve patent search results and related trademark information with the same search.

Some search engines, such as the Internet search engine hosted by Google®, make it possible to retrieve data from one or more data sources through key word searches. While such search engines may retrieve trademark data from one data source and patent data from another, search results from different data sources are typically aggregated into a set of search results ranked according to an estimated relevance to the search query.

Accordingly, embodiments of embodiments of a system and methods are disclosed below that automate a process of relating trademarks and patent documents.

### SUMMARY

Systems and methods are disclosed that can be used to automatically relate data from different databases and/or different data sources that may include some similar, but not identical categories, which may be expressed in different terms and used for different purposes. In one particular example, systems and methods are disclosed to relate trademarks and patent documents, where patent documents can include both issued patents and published patent applications, and where the term “trademark” refers to trademarks, which are applied to goods, and service marks used in connection with services. In some instances, the systems and methods can be used to relate trademarks to data other than patent documents, including, for example, as financial data, enterprise resource planning data, litigation data, proprietary corporate data, and the like.

In an embodiment, a computer-readable medium embodies instructions that, when executed by at least one processor, cause a computing system to perform operations including automatically defining one or more associations between a trademark record and a patent document and storing the one or more associations as mappings between trademarks and patent documents.

In another embodiment, a method of associating trademarks and patent documents includes extracting data from a trademark record of a plurality of trademark records using an extract-transform-load module of a correlation system the method further includes automatically defining one or more associations between the trademark record and patent documents of a plurality of patent documents based on the extracted data using mapping logic of the correlation system and storing the defined one or more associations as mappings within a plurality of mappings between trademark records and patent documents in a computer-readable memory.

### BRIEF DESCRIPTION OF THE DRAWINGS

FIG. 1 depicts an embodiment of a system, in block form, to relate trademarks and patent documents.

FIG. 2 depicts, in block form, an embodiment of the correlation system, illustrated in FIG. 1, including an extract-transform-load module and mapping logic.

FIG. 3 depicts an embodiment of a trademark record encoded with hypertext markup language (HTML) tags retrieved from the Trademark Electronic Search System through the United States Patent and Trademark Office website.

FIG. 4 depicts a table including data extracted from the trademark record illustrated in FIG. 3.

FIG. 5 depicts a revised version of the table of FIG. 4.

FIG. 6 depicts an example of a mapping table depicting sample mapping data between a patent document and the trademark data illustrated in FIG. 5.

FIG. 7 depicts a second example of a mapping table illustrating a mapping between a patent document and the trademark record illustrated in FIG. 5.

FIG. 8 depicts a diagram, in block form, depicting mappings between patent documents and trademark records.

FIG. 9 depicts an example of multiple mapping tables illustrating multiple mappings.

FIG. 10 depicts a flow diagram of an embodiment of a method of relating trademarks and patent documents.

FIG. 11 depicts a flow diagram of an embodiment of a method of relating trademarks and patent documents to produce weighted mappings.

FIG. 12 depicts a flow diagram of a method of weighting mappings between trademarks and patent documents based on ancillary data from other data sources.

FIG. 13 depicts an embodiment, in block form, of the search system illustrated in FIG. 1.

FIG. 14 depicts a flow diagram of an embodiment of a method of searching one or more data sources using the search system illustrated in FIG. 13.

FIG. 15 depicts a flow diagram of an embodiment of a method of automatically retrieving trademarks s using the search system illustrated in FIG. 13.

FIG. 16 depicts an example of a method of searching using the search system illustrated in FIG. 13 to retrieve search results and related data.

FIGS. 17-20 depict embodiments of interfaces generated by the search system illustrated in FIG. 13,including data related to search results.

### DETAILED DESCRIPTION

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the inventive subject matter. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure can include a variety of combinations and/or integrations of the embodiments and examples described herein, as well as further embodiments and examples as defined within the scope of all claims based on this disclosure, as well as all legal equivalents of such claims.

For the purposes of this specification, a “computing device” or “computing system” includes a system that uses one or more processors, microcontrollers and/or digital signal processors to access a computer-readable data storage medium (such as a hard disk storage medium and/or a solid-state data storage medium) and that has the capability of running a “program.” As used herein, the term “program” refers to a set of executable machine code instructions, and as used herein, includes user-level applications as well as system-directed applications or daemons, including operating system and driver applications. Computing devices or systems include mobile phones (cellular or digital), music and multi-media players, and Personal Digital Assistants (PDA); as well as computers of all forms (including desktops, laptops, servers, palmtops, workstations, etc.). Further, it should be understood that, in some embodiments, the term “computing system” can refer to systems that include multiple computing devices, and that associated processing functionality may be distributed among the computing devices, such as in a multiple-server system.

The following discussion generally relates to a specific example to explain mapping of trademarks to patent documents. As used herein, the term “trademarks” refers to marks that are applied to goods as well as marks that are used in connection with services. Further, as used herein, the term “patent documents” refers to issued patents and published patent applications, including those issued or published by an official patent authority, such as the United States Patent and Trademark Office, the European Patent Office, the World Intellectual Property Association, foreign patent offices, or other officially sanctioned patent authority.

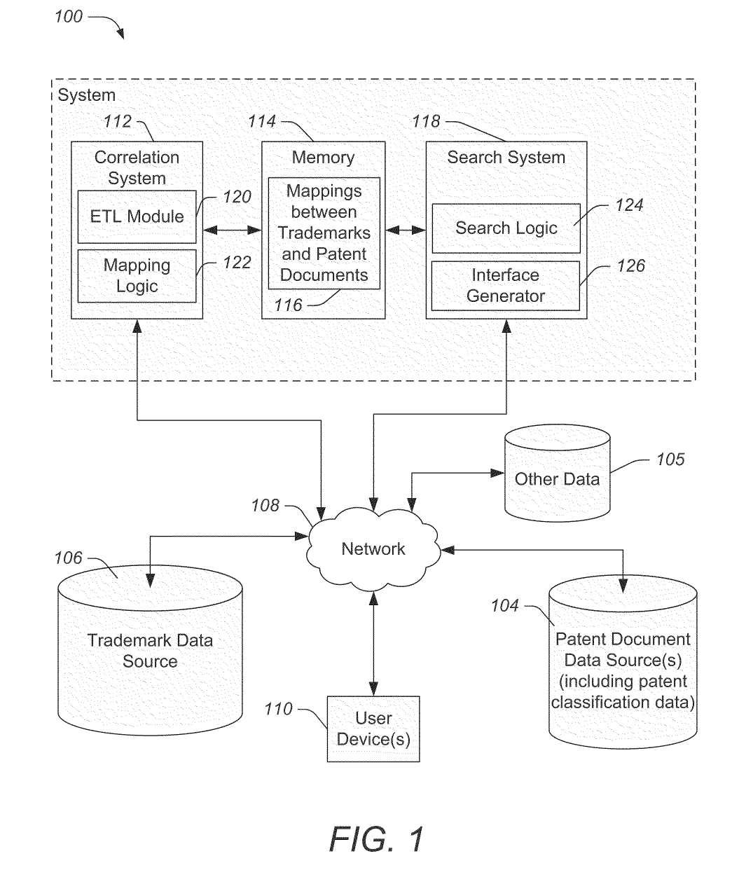

Embodiments described below with respect to FIGS. 1-20 will describe associating trademarks to patent documents for simplicity, but the association between trademarks and patent documents can be generated in either direction, and thus reverse mapping is equally significant. In particular, each mapping is bi-directional, making it possible to search trademarks to find patent documents or to search patent documents to find trademarks. Further, the discussion below focuses on associations (mappings) between trademarks or trademark records and patent documents for simplicity of following through with the example; however, it should be understood that such associations can be created for data extracted from different types of data, including database records, structured text documents (such as forms), semi-structured text documents (such as web pages), and unstructured documents, such as images, audio data, video data, and text without embedded tags. Further, such data can be extracted from different data sources (multiple different data sources) or from different types of data sources, such as databases, text documents, and web pages hosted on web sites and accessible over the Internet.

The specific examples of associating trademarks and patent documents provide a simple framework within which to describe the systems and methods. In particular, trademark records generally have short, well-defined descriptions (and therefore fewer, readily classified words) than patent documents or other randomly selected documents. Thus, trademarks provide a useful framework in which to describe methods of relating trademarks (or trademark records) and patent documents. However, it should be understood that any such associations (mappings) are bidirectional and can be used to retrieve patents in response to a trademark query or vice versa. Further, such associations can be used to relate trademarks to other types of documents, which may already be related to the patent documents.

### A. System Overview

In an embodiment, a computing system automatically identifies associations between trademarks (or trademark records) and patent documents through a plurality of attributes, including textual similarity, common ownership, names of people, geographical location, date information, etc. The computing system processes trademark records against a plurality of patent documents including issued patents and published patent applications to identify one or more associations between each trademark and each patent document and to store the one or more associations in a memory as mappings between trademark records and patent documents. In some instances, the computing system further processes the mappings to rank or weight each mapping based on one or more ranking algorithms. Further, in some instances, the computing system also processes trademark records against existing classifications, such as United States patent classifications, International patent classifications, industry classifications, and other classifications to identify associations between trademark records and patent classifications.

FIG. 1 depicts an embodiment of a system 100, in block form, to relate trademarks and patent documents. System 100 includes correlation system 112 that is configured to relate trademarks and patent documents to generate mappings between trademarks and patent documents 116, which are stored in memory 114. Correlation system 112 is configured to retrieve trademark data from trademark data source 106, patent data from one or more patent document data sources 104, and other data 105 through network 108, such as the Internet.

Patent and trademark data sources 104 and 106 includes publicly available data, such as patent database records, published patent applications database records, trademark database records, and text from the United States Patent and Trademark Office web site or hosted by other patent or trademark document authorities (such as the European Patent Office, the World Intellectual Property Organization, and other foreign patent authorities), proprietary information, etc. Text from the United States Patent and Trademark Office web site includes trademark classification information (such as trademark classification name (title) and descriptive text) and patent classification information (such as patent classification name (title) and descriptive text). Other data 105 includes websites, databases, whitepapers, and other public or private data sources accessible to correlation system 112. In some instances, other data 105 can include enterprise resource planning (ERP) data and other data that is proprietary to a particular company.

Correlation system 112 includes an extract-transform-load (ETL) module 120 to extract, transform, and load data from one or more data sources into a table or matrix using, ETL module 120 can include one or more ETL processes configured to process various types of data. In an example, ETL module 120 extracts trademark data from a plurality of trademark records. Such extracted data includes numeric identifiers (such as trademark application numbers and registration numbers), trademark names, trademark descriptions of goods and services, ownership data, date information, and trademark classifications data. ETL module 120 can also be used to extract patent data from the plurality of patent documents. ETL module 120 is preferably configured to extract data from any text document, including hypertext markup language (HTML) and extensible markup language (XML) documents. ETL module 120 can also be used to extract data from various types of databases, including SQL databases, for example. In some instances, separate ETL modules may be provided to extract different types of data or to process data from different data sources.

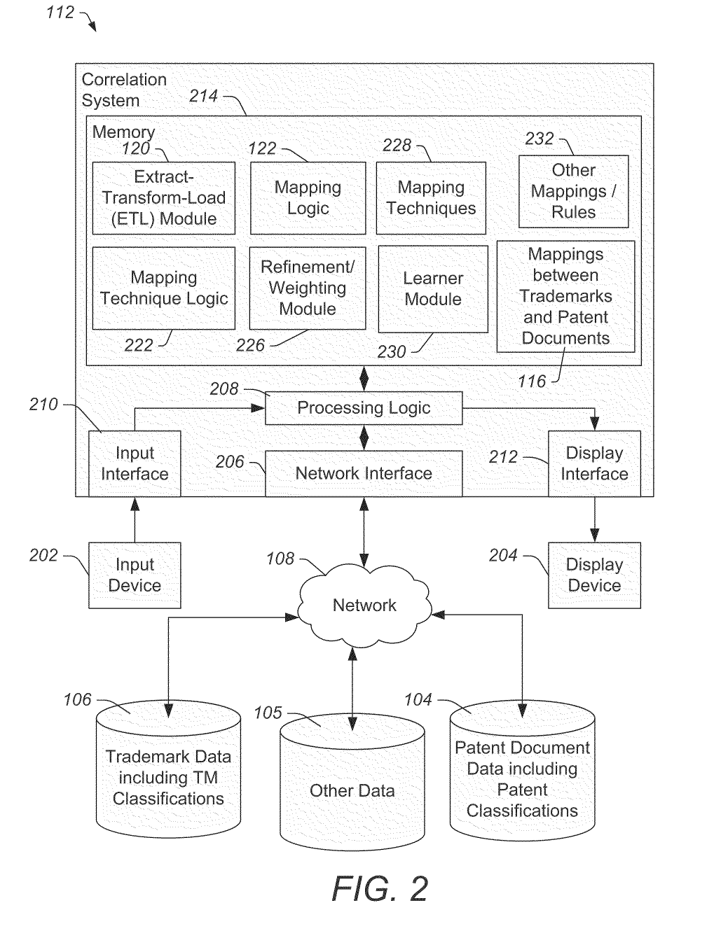

Further, correlation system 112 includes mapping logic 122 to process the extracted data. Mapping logic 122 automatically identifies (defines) one or more associations between a trademark record and a patent document, and correlation system 112 stores the one or more associations in memory 114 as mappings between trademarks and patent documents 116. In an example, mapping logic 122 processes the extracted trademark data to identify matches between each trademark record from the trademark data source 106 and each patent document of the patent document data sources 104 and to produce mappings between trademarks and patent documents 116 based on such identified related data. In particular, mapping logic 122 processes selected terms extracted from each trademark record against text from each patent document to produce the mappings between trademarks and patent documents 116. Further, mapping logic 122 can process selected terms extracted from each trademark record against one or more existing classifications, such as text of United States patent classifications or International patent classifications. Additionally, mapping logic 122 can be used to map other data 105 to trademark data or patent document data. Correlation system 112 and its operation are described in further detail below with respect to FIGS. 2-12.

Each mapping represents a bi-directional association (trademark-to-patent and patent-to-trademark) based on one or more word or number matches (or semantic associations) between a trademark record and a patent document. Each trademark record may be mapped to a patent document through multiple matches or associations. Further, each trademark record may be mapped to multiple patent documents (and vice versa). Such mappings can be used as a “Rosetta Stone” to translate search terms, concepts, and extracted data between patent documents and trademarks, between patent and trademark data sources 104 and 106, and between trademarks and other types of documents. For example, mappings between trademarks and patent documents 116 can be used to relate search results from one data source to trademark data through a third data source that is already correlated to the patent documents (or more generally to the patent classifications). Further, while the above-discussion is directed to trademark-to-patent mappings, mapping logic 122 can map trademarks to any number of data sources, including documents, classifications, and other data 105. Additionally, mapping logic 122 can be used to map patent documents to trademarks or other data sources to trademarks.

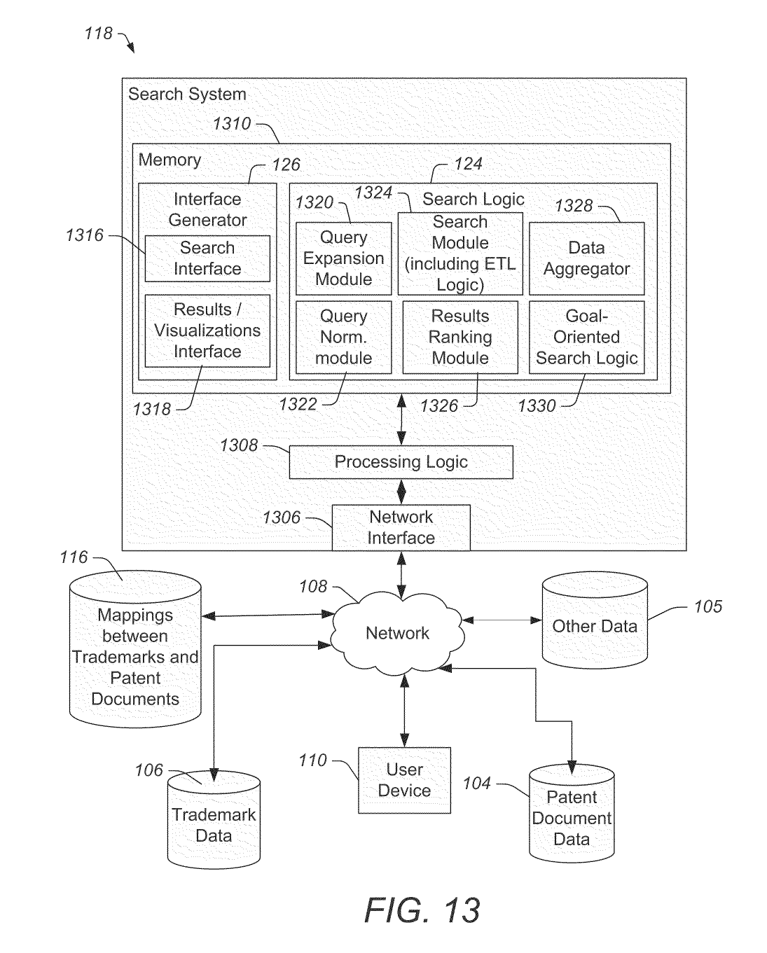

Referring again to system 100 in FIG. 1, system 100 further includes search system 118 coupled to memory 114 and having access to mappings between trademarks and patent documents 116. Search system 118 includes a graphical user interface (GUI) generator 126 to produce a search interface that can be provided to one or more user devices 110 (such as a computing device) through network 108. Search system 118 receives user input from user devices 110 that is related to the search interface and uses search logic 124 to perform one or more searches and to retrieve and process search results. Search logic 124 provides the processed search results to interface generator 126, which generates a GUI including the processed search results and transmits the GUI to user device 110 through network 108. Search system 118 is described in greater detail below with respect to FIGS. 13-17.

In an embodiment, search logic 124 can translate search queries received from user device 110 into multiple formats and forms for searching different data sources. For example, the one or more patent document data sources 104 may use different search structures. In one example, a first patent document data source can be queried using Boolean search logic (including logical operators such as AND, OR, ANDNOT, and the like) and a second patent document data source uses different indicators (such as “+” and “−”) to indicate logical operations. Other data sources, such as other data source 105, may use proprietary query structures. Search logic 124 is configured to translate a received query into formats appropriate for each data source, to send the translated queries to the various data sources, and to process search results into a set of search results.

In one embodiment, search logic 124 extracts data from the search results, searches mappings between trademarks and patent documents 116 using the extracted data to identify related mappings, and retrieves data from trademark data source 106 based on the identified mappings. Search logic 124 can associate the retrieved trademark data with the previous search results and provide the search results to the GI generator 126, which will generate a GUI including the search results and transmit the GUI to the user device 110.

As is apparent from the above description, certain systems, apparatus or processes are described herein as being implemented in or through use of one or more “modules.” A “module” as used herein is an apparatus configured to perform identified functionality through software, firmware, hardware, or any combination thereof. When the functionality of a module is performed in any part through software or firmware, the module includes at least one machine readable medium (such as memory 214 depicted in FIG. 2 below) bearing instructions that, when executed by one or more processors, causes a computing system to perform that portion of the functionality implemented in software or firmware.

between trademarks and patent documents

In the following discussion, aspects of system 100 are described in further detail. The discussion, including the discussion of the above-described system 100, is organized according to the following general outline:

A. Overall System 100 (FIG. 1)

### B. Correlation System 112 (FIG. 2)

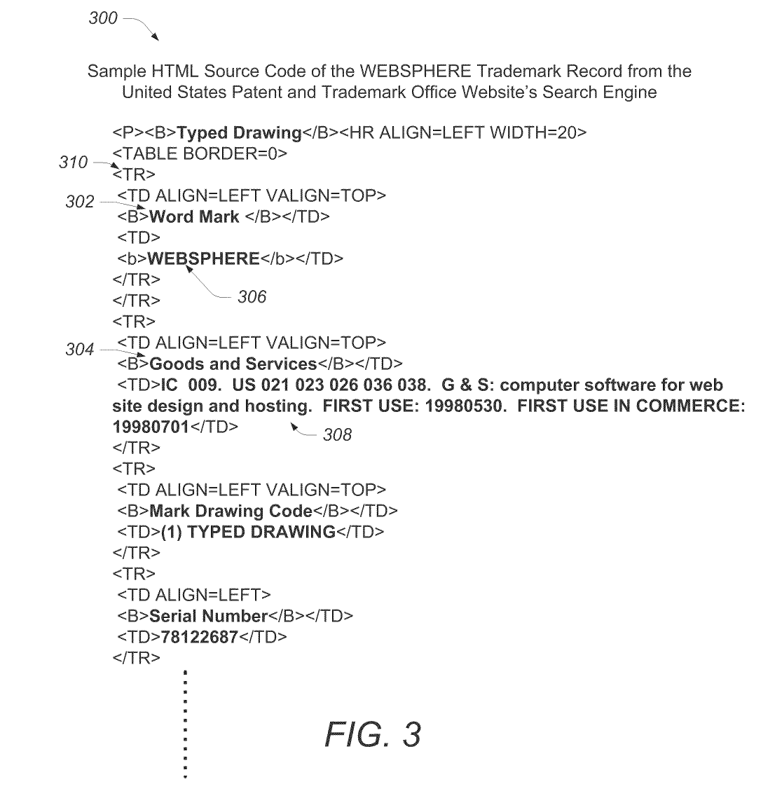

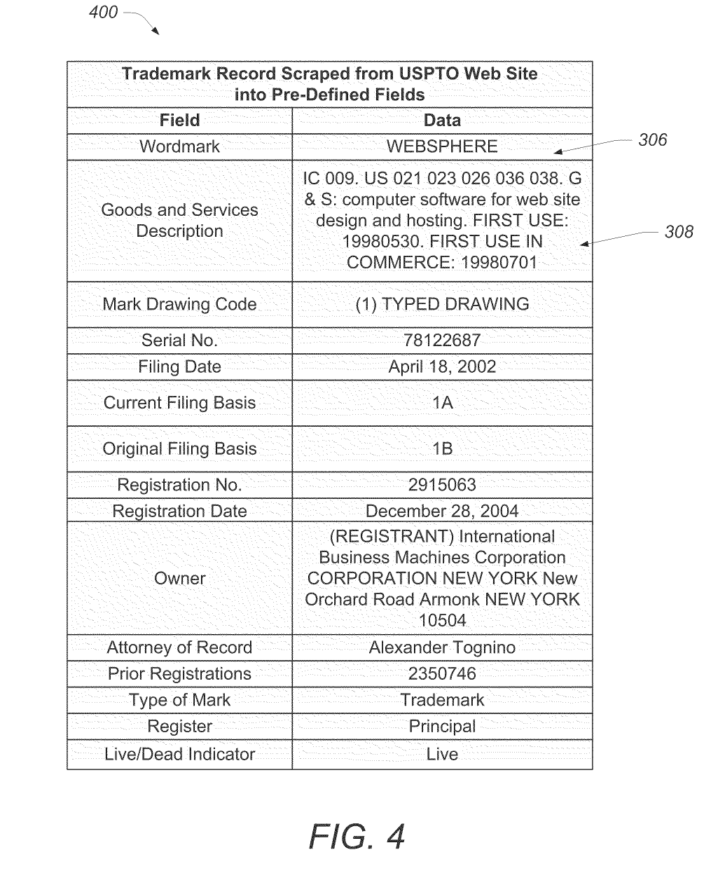

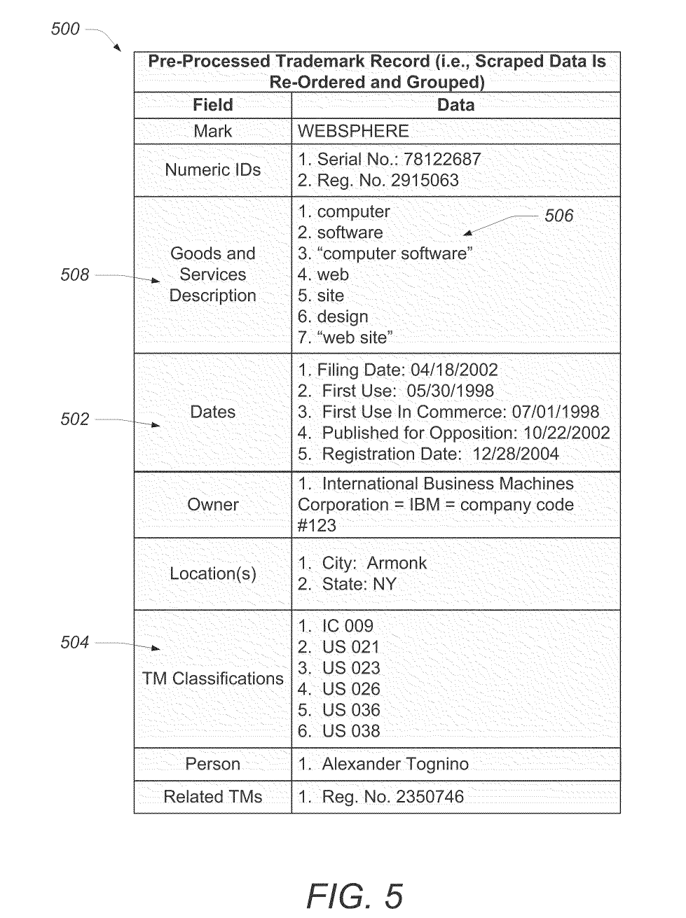

1. Trademark Record 300 (FIG. 3)
a. Data from Trademark Record 300 (FIG. 4)
b. Revised data 500 (FIG. 5)

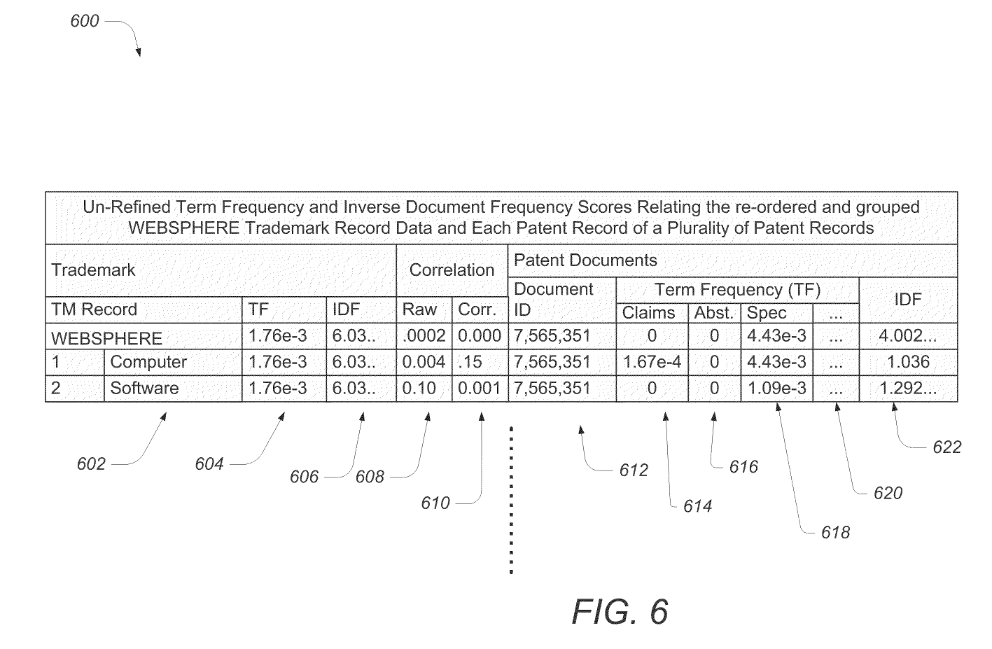

2. Mappings 116 and mapping tables (FIGS. 6-9)

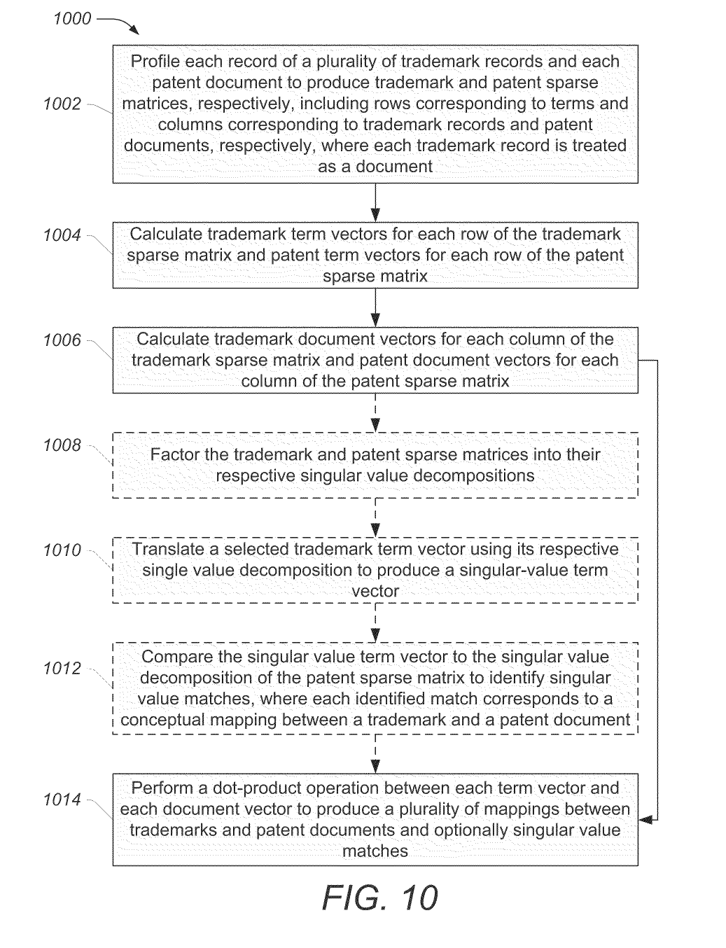

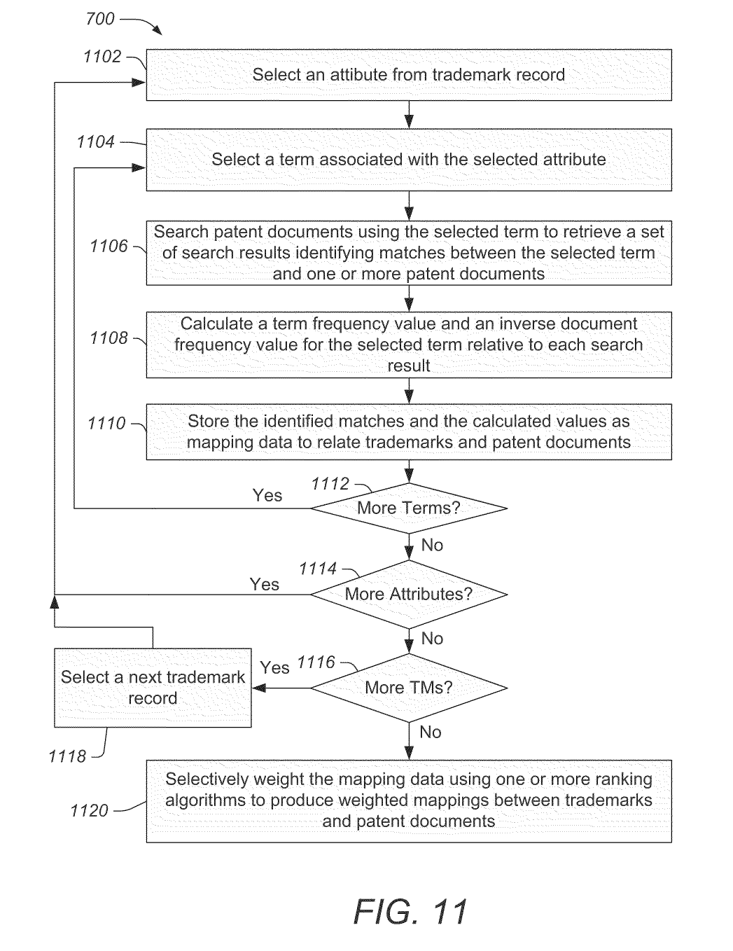

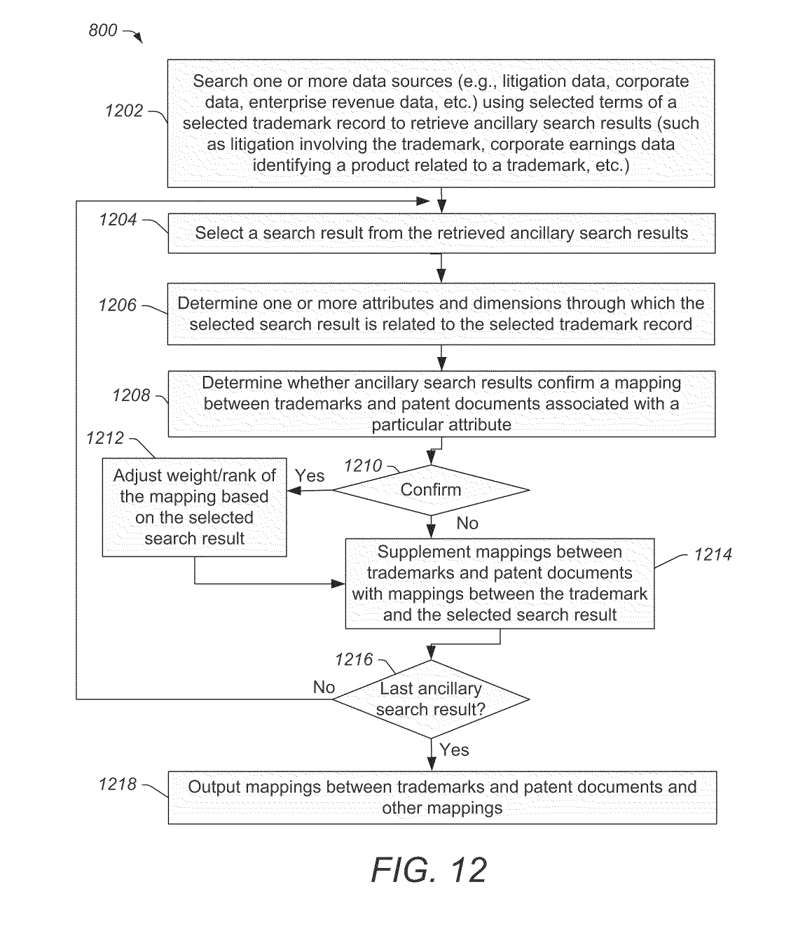

3. Method to relate trademarks and patent documents (FIG. 10)
a. Method of weighting Mappings (FIG. 11)
b. Second method of weighting Mappings (FIG. 12)

### C. Search System 118 (FIG. 13)

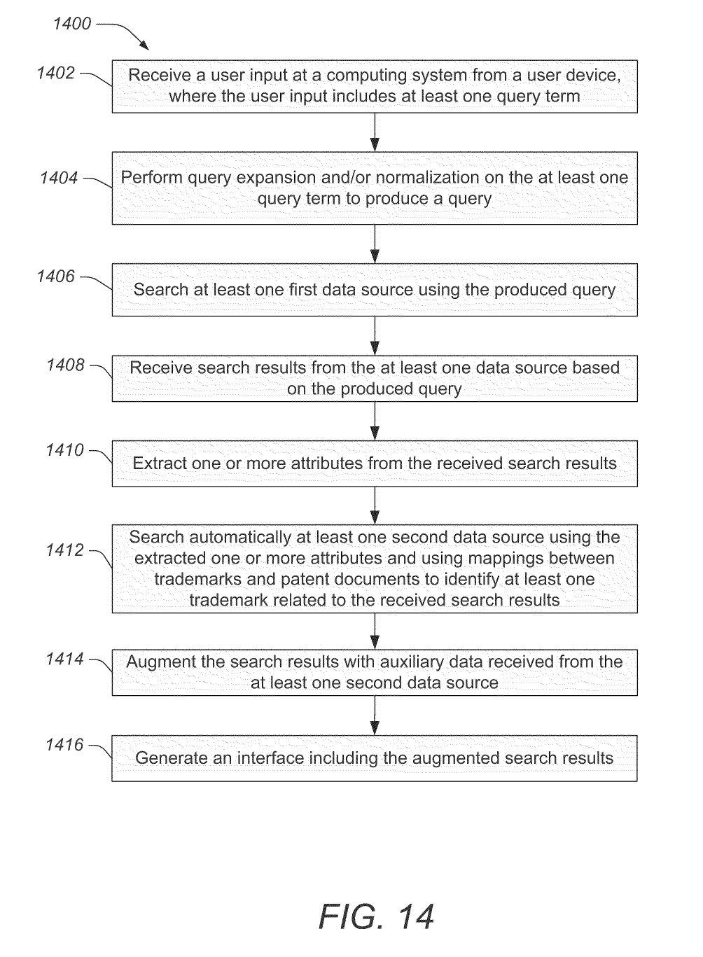

1. Methods of Searching (FIGS. 14-16)

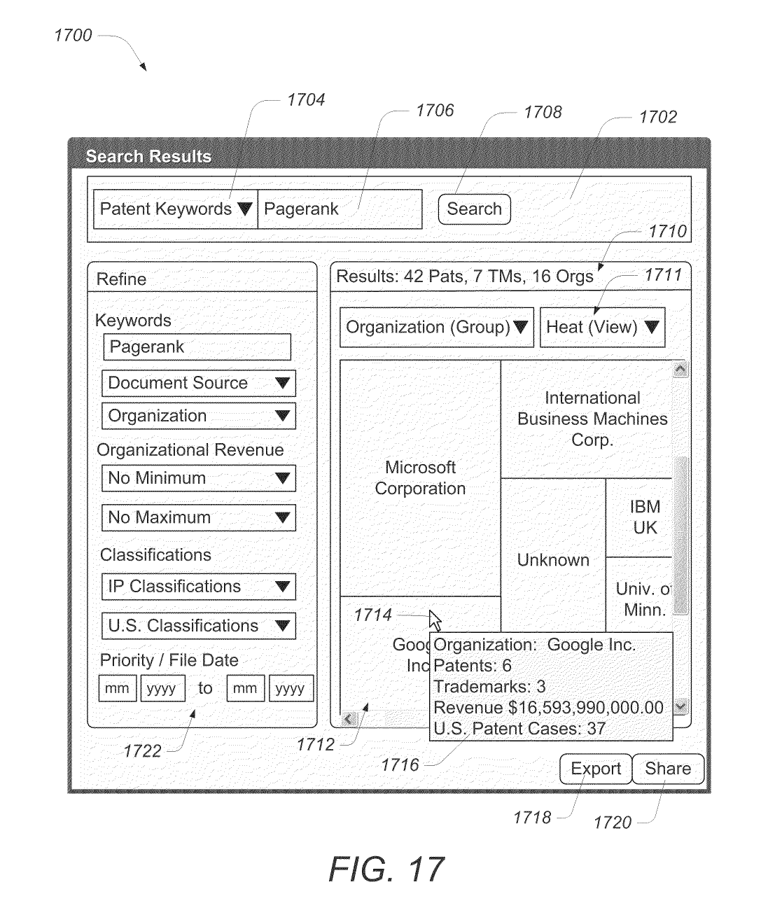

2. Illustrative Search Results Interfaces (FIGS. 17-20)

### B. The Correlation System

FIG. 2 depicts, in block form, one possible embodiment of the correlation system 112 illustrated in FIG. 1. Correlation system 112 includes a network interface 206 that communicates with network 108. Network interface 206 is coupled to processing logic 208. Processing logic 208 is coupled to memory 214, to input device 202 through input interface 210, and to display device 204 through display interface 212.

Memory 214 includes ETL module 120 that is executable by processing logic 120 to extract, transform, and load data from a variety of data sources, including trademark data source 106, into tables, such as those depicted in FIGS. 3-5 and described below, for further processing. Memory 214 also includes mapping logic 122 to identify associations between the extracted data and data from other data sources, such as patent data source 104 to produce mappings between trademarks and patent documents 116, which can be represented as mapping tables, such as mapping tables depicted in FIGS. 6-9 and described below.

Additionally, memory 214 includes mapping technique logic 222 configured to select one or more mapping techniques 228 based on a type of data to be mapped. For example, mapping of a numeric identifier to a matching numeric identifier in another document may be performed using a simple search. In another example, mapping of text from a description of goods/services of a trademark record to text of a patent document may utilize more robust mapping techniques, such as latent semantic analysis, a naive-Bayes classification, Latent Dirichlet Allocation (LDA), or other types of natural language processing techniques. In another example, mapping of a trademark owner to an assignee or inventor of a patent may utilize a two-tier, “brute force” (term-by-term) search, involving a look up to a table of pre-defined globally unique identifiers (which can including mappings of variations in spelling of a corporate name or individual name to an unique identifier) and including a search using the globally unique identifier. Other types of mapping techniques can also be used. Mapping technique logic 222 is adapted to select an appropriate mapping technique for a given piece of data and to control mapping logic 122 to selectively apply the selected mapping technique.

In an embodiment, mapping logic 122 may apply each possible mapping technique to each piece of data and aggregate the results to produce a composite weighted mapping value for each piece of data. In another embodiment, mapping logic 122 selectively applies different mapping techniques based on which attribute is being mapped (i.e., trademark owner versus trademark description of goods/services).

Refinement/weighting module 226 is executable by processing logic 208 to selectively refine one or more mappings between a particular trademark and a particular patent document. In one instance, refinement/weighting module 226 is accessible by a user through input device 202 to manually adjust mappings, such as by pruning duplicate mappings, removing erroneous mappings, etc. In another instance, refinement/weighting module 226 may operate in the background, automatically adjusting or refining mappings based on data retrieved from other data sources 105, such as ancillary data derived from web sites. Further, refinement/weighting module 226 is configured to selectively adjust mapping scores, such as by adjusting weights or relevancy rankings assigned to each mapping.

In one example, refinement/weighting module 226 can adjust a mapping between a service mark and a patent classification by limiting such a mapping to “business methods” types of patent classifications, such as United States Patent Classifications 705 through 707, for example, and pruning or otherwise devaluing ranks of other classifications. In another example, refinement/weighting module 226 can adjust a mapping between a trademark and a patent document based on ancillary data, such as data extracted from a whitepaper that confirms a relationship between the trademark and the patent document. In still another example, refinement/weighting module 226 can adjust a mapping between a trademark and a patent document based on document statistics derived from one or both of trademark data source 106 and patent data source 104.

In an embodiment, memory 214 can include learner module 230, which can be trained to map new data into an existing set of classifications or categories. In some instances, static mappings between trademarks and patent documents 116 may be incomplete (such as when new trademark applications are filed) or may not include a particular query term. In such an instance, learner module 230 can be used to apply mapping logic 122 to identify related information and/or to associate new information with the set of classifications. In one particular example, learner module 230 can use a bounded learning model where the target function for mapping the data has a real-valued output scaled to a probability between zero and one. Learner module 230 is trained through a learning session that includes a set of trials. In each trial, the learner module 230 is given an unlabeled set of text documents, such as an unlabeled set of patent documents (with patent classification data removed), which it can classify or associate with the set of patent classifications (for example). The learner module 230 applies a current hypothesis (or set of mapping rules and mapping techniques) to predict a probability for each document relative to, for example, each of the international patent classifications and makes an estimate for each patent document as to which class or classes it belongs. The learner module 230 is then provided the correct mappings (i.e., the actual patent classifications for each patent document). The learner module 230 is configured to adjust its hypothesis to reduce errors and to repeat the learning process with another training set. Over a number of learning trials, learner module 230 improves its performance. In an example, learner module 230 is configured to tweak parameters associated with mapping techniques 228 to improve its mapping to a desired performance level.

Once the learner module 230 is trained, new data provided to the learner module 230 (such as extracted trademark data) can be readily associated with a given patent classification, making it possible to dynamically relate new data or queries (for example) to one or more related patent classifications. While such general associations are not reliable to surface precise results, the associations to the classifications can be used to narrow or direct a search within a particular subject area, making it possible to surface trademarks related to random query terms, even when direct mappings between trademarks and patent documents 116, for example, do not include such mappings.

In general, mapping of text to international patent classifications is preferred over mapping of text to trademark classifications, in part, because there are more classes and subclasses within the international patent classifications, providing relatively more granularity within the classifications. However, other types of classifications may be used, including, for example, industry classifications, proprietary classifications, and the like. Further, multiple learner modules, such as the learner module 230, can be included and can be trained to map different types of data to the same set of classifications, providing translation to associate different types of data to the set of classifications. In some instances, it may be possible to train a learner module to map between different languages, so that, for example, untranslated texts can be mapped to the set of classifications as well.

Learner module 230 can be a bounded learner, such as that described above, or another type of learner, such as an artificial intelligence, a neural network, a rule-based learner, or some other algorithm designed to dynamically adjust its performance and/or to utilize mapping logic 122, mapping technique logic 222, and mapping techniques 228 to enhance its performance. In a particular embodiment, learner module 230 may control and coordinate operation of ETL 120, mapping technique logic 222, mapping logic 122, and refinement/weighting module 226 to produce mappings between trademarks and patent documents 116 as well as other mappings/rules 232, such as mappings between trademarks and other data 105, mappings between patents and other data 105, mappings between different types of data, and/or rules for processing new data to identify relationships.

It should be understood that modules 120, 122, 222, 226, and 230 are depicted for illustrative purposes only. Not all of the modules may be needed in every implementation. Further, in some instances, modules may be combined and other modules may be added without departing from the spirit and the scope of the disclosure. Additionally, though mappings between trademarks and patent documents 116 and other mappings/rules 232 are depicted within memory 214, it should be understood that they may be external to correlation system 112. Further, in some instances, other mappings/rules 232 may be stored with mappings between trademarks and patent documents 116 in a single data store.

FIG. 3 depicts an embodiment of a trademark record 300 encoded with hypertext markup language (HTML) tags retrieved from the Trademark Electronic Search System (TESS) through the United States Patent and Trademark Office website. In this example, the trademark record 300 includes data for the trademark WEBSPHERE. The trademark record 300 includes data identifiers, such as “Word Mark” 302 and “Goods and Services” 304, interspersed with corresponding data items 306 and 308 and with hypertext coding, such as table row code “<TR>” 310.

ETL module 120, depicted in FIG. 1, removes the HTML coding and extracts the data 306 and 308, such as the mark “WEBSPHERE” and the associated text of the description of goods and services. In a structured data format such as that provided by search results from TESS, field names can be derived from the tags or labels included within the HTML document. For example, ETL module 120 could utilize data identifiers 302 and 304 as labels for the extracted data 306 and 308. In another example, the data identifiers 302 and 304 can be discarded, and the extracted data 306 and 308 can be populated into a pre-existing table or database, such as table 400 depicted in FIG. 4.

FIG. 4 depicts a table 400 including data extracted from the trademark record illustrated in FIG. 3. Table 400 includes pre-existing fields, though, as mentioned above, such fields could be derived from the data identifiers 302 and 304 depicted in FIG. 3. As can be seen in table 400, data extracted from trademark record 300 in FIG. 3 may require further processing. For example, description of goods and services data 408 includes international trademark classification data “IC 009,” United States trademark classification data “US 021 023 026 036 038,” an abbreviation “G&S,” punctuation (such as colons and periods), and date information, including “FIRST USE: 19980530” and “FIRST USE IN COMMERCE: 19980701.” To utilize such information, it may be desirable to reorganize the received data into various fields or buckets. Accordingly, ETL module 120 is adapted to process the extracted data and to transform the data into a revised version of the table, generally indicated at 500 in FIG. 5.

FIG. 5 depicts a revised version 500 of the table 400 illustrated in FIG. 4. In this example, data from description of goods and services data 408 is extracted, transformed, and loaded into revised version 500 into one or more data fields 502, one or more trademark classification fields 504, and one or more descriptions of goods and services fields 508. For example, ETL module 120 extracts date information from the description of goods and services 408 in FIG. 4 and groups the extracted date information into one or more date fields 502. Further, ETL module 120 organizes other text and numeric items. For example, ETL module 120 extracts International and United States trademark classifications from the description of goods and services 408 in FIG. 4 and organizes them into one or more trademark classification fields 504. Further, ETL module 120 is configured to remove “stop words” (such as “the,” “a,” “namely,” and other words that appear in most, if not all, trademark records) and miscellaneous connectors (such as “and,” “or,” “including” and other connecting phrases and terms) from the description of goods and services 408 in FIG. 4 and to organize the remaining terms from the description of goods and services 408 into one or more terms or phrases associated with description of goods and services field 508, such as the list depicted at 506.

It should be understood that the tables depicted in FIGS. 3-5 are provided for illustrative purposes only and represent only one possible technique for organizing the extracted trademark data. In an alternative embodiment, ETL module 120 extracts each term from the trademark record and places each unique term in a different row and places each trademark record in a different column to produce a trademark matrix. Thus, table 500 depicted in FIG. 5 can be expanded to represent a profile of a set of trademark records, where each row represents a term and each column represents a trademark record or document. Similarly, a profile matrix can be assembled for each of the unique trademark terms with respect to each patent document.

In another alternative embodiment, ETL module 120 operates in conjunction with mapping logic 122 to extract, process, and store trademark text directly into one or more mapping tables or matrices that relate trademarks and patent documents, without creating intermediate tables or matrices. In another embodiment, ETL module 120 scrapes data from the trademark record and provides the scraped data directly to mapping logic 122, which maps the extracted data directly without organizing the data. In still another embodiment, ETL module 120 extracts, transforms, and loads data into a database, such as a relational database, instead of into a “flat file” or spreadsheet type of table.

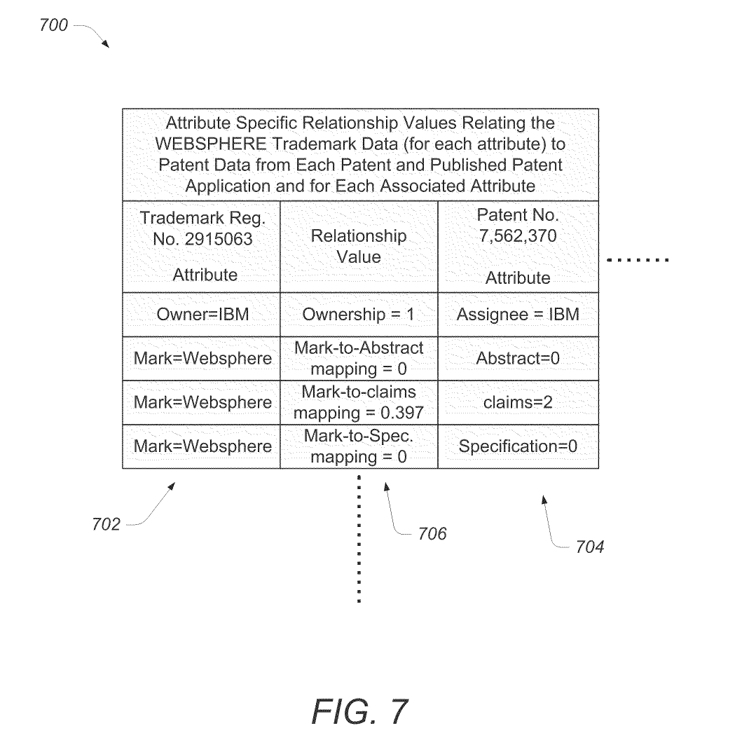

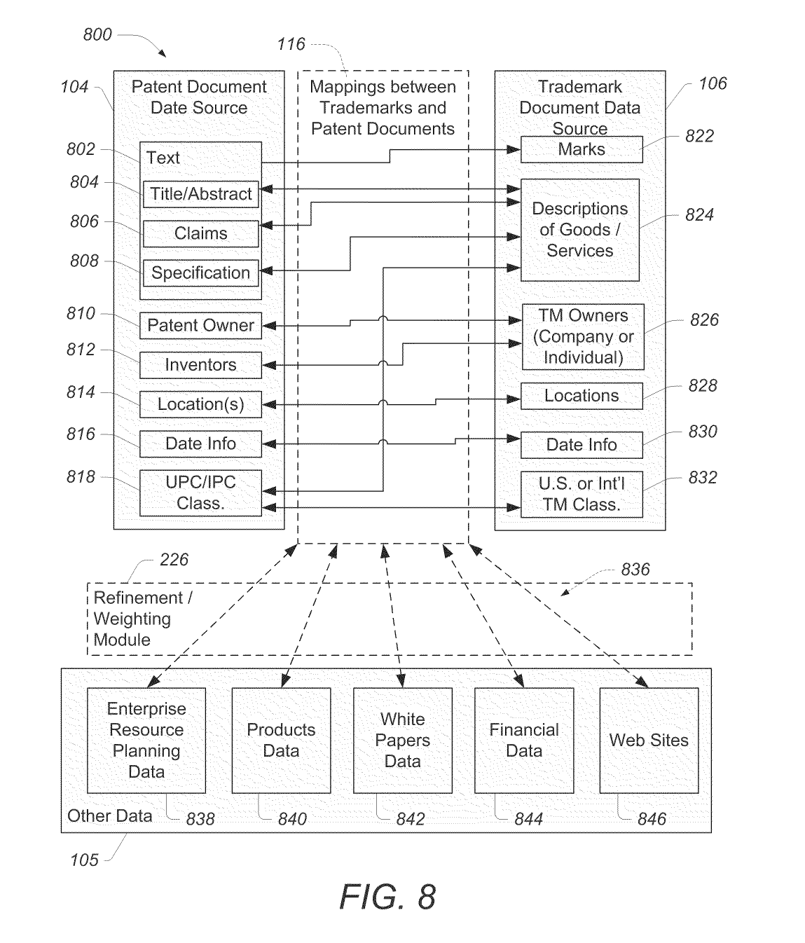

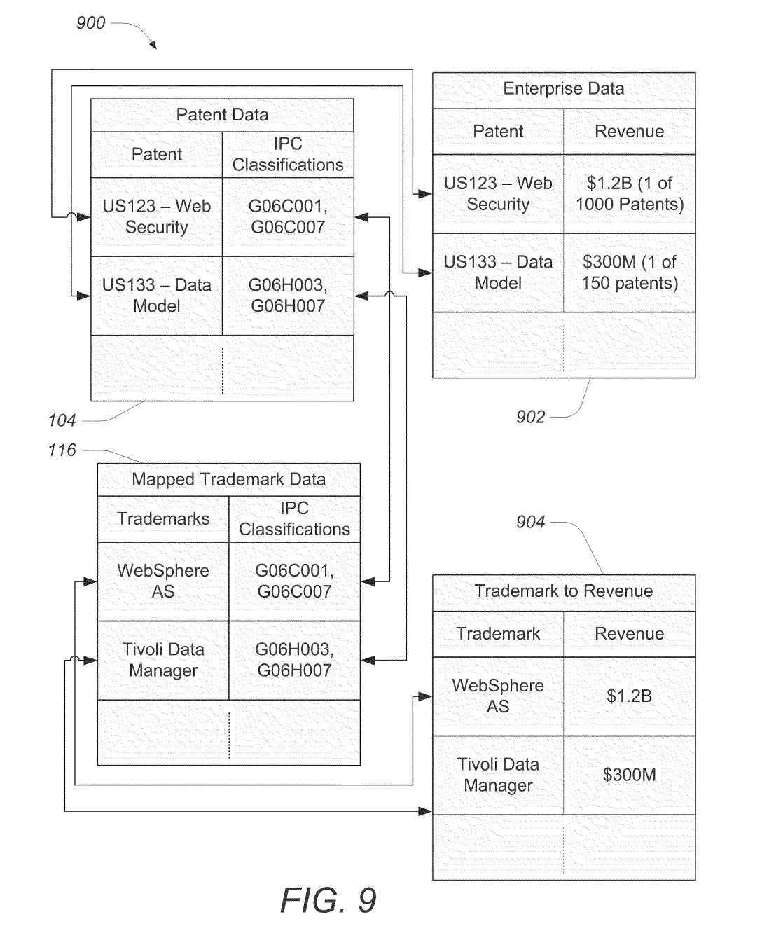

Once data is extracted, transformed and loaded from one source into a usable form, the data can be mapped or otherwise related to other data. Methods of performing such mapping are discussed below with respect to FIGS. 10-12. However, before discussing how such mappings are created, the example of mapping trademarks and patent documents is continued below with respect to FIGS. 6-9. FIGS. 6-7 depict mapping tables illustrating mappings between patent document data and trademark data of table 500 in FIG. 5. FIGS. 8-9 depict mappings between patent documents and trademarks across multiple attributes and mappings between mapping tables, respectively.

FIG. 6 depicts an example of a mapping table 600 depicting sample mapping data between a patent document and the trademark data illustrated in FIG. 5. Mapping table 600 includes extracted text 602 from trademark record 500 depicted in FIG. 5 or the mark WEBSPHERE. Additionally, mapping table 600 includes associated trademark term frequency 604 derived from trademark record 500 and trademark inverse document frequency data 606 derived from data extracted from trademark data source 106.

Further, mapping table 600 includes patent document identifier 612 and associated match frequency data for the claims 614, abstract 616, and specification 618 for a patent record for U.S. Pat. No. 7,565,351, which patent document includes the term “websphere.” Additionally, mapping table 600 includes term frequency data 620 and inverse document frequency data 622 for each trademark term relative to the patent document and to the set of patent documents, respectively. Further, correlation values are calculated for each term relative to the patent. The correlation values, both raw and corrected (adjusted), may be determined from a combination of the term-frequency and inverse-document frequency values 604, 606, 614, 616, 618, 620, and 622 to provide a score, such as a raw score 608 and a correlation score 610, for each possible mapping.

In another example, table 600 can include an aggregated mapping score for each attribute of the trademark and/or for each association between trademarks and patent documents as a whole. Further, it should be understood that table 600 represents a simplified table. In an alternative embodiment, mapping logic 122 is adapted to generate multi-dimensional related tables that can include each trademark and each patent and their weighted mappings defining relationships through one or more attributes.

FIG. 7 depicts a second example of a mapping table 700 illustrating a mapping between a patent document and the trademark record illustrated in FIG. 5. In this example, trademark record 702 represents data extracted from the trademark record depicted in table 500 in FIG. 5. Trademark record 702 is mapped to patent document 704, which corresponds to U.S. Pat. No. 7,562,370. Each of the mappings 706 includes an independent score. In this instance, the trademark and the patent document are commonly owned, which common ownership is reflected in a probability score of 1 (indicating a 100% match) for the particular mapping. Further, other mappings between trademark record 702 for the mark WEBSPHERE and abstract, claims, and specification text of patent record 704, also exist, which mappings 706 reflect the appearance of the mark WEBSPHERE in various portions of the patent document. Though not shown, it should be understood that table 700 also includes mappings of terms from the description of goods and services of trademark record 702 and other portions of a trademark record. Further, table 700 may include each trademark record and each patent document identifying mappings between each trademark and each patent document.

FIG. 8 depicts a diagram 800, in block form, depicting multiple mappings between patent documents and trademark records. Diagram 800 includes mappings between patent documents data source 104 and trademark records data source 106 to produce mappings between trademarks and patent documents 116. Each patent document includes text 1002 including title/abstract text 1004, claims text 1006, and specification text 1008. Further, each patent document includes patent owner data 1010, inventor data 1012, location data (such as the city and state associated with each inventor and the assignee) 1014, date information (such as priority date, filing date, publication date, and issue date) 1016, and classification data (such as International patent classifications and U.S. Patent classification data) 1018.

Each trademark record of trademark document data source 106 includes a name of the mark 1022, a description of goods/services 1024, trademark owner information (company or individual) 1026, location information (such as a city and state associated with the trademark owner) 1028, date information (e.g., date of first use, date of first use in commerce, filing date, issue date, etc.) 1030, and classification data (U.S. trademark classification and International trademark classifications) 1032.

Mapping logic 122 generates mappings between trademark records from trademark record data source 106 and patent documents from patent document data source 104. As discussed above, such mappings can include one or more associations between data of a patent document and data from a trademark within each category or attribute.

Such mappings between trademarks and patent documents 116 can be refined based on ancillary data 836 derived from other data 105 using refinement/weighting module 226 depicted in FIG. 2. In one instance, mappings between trademarks and patent documents 116 are adjusted or refined by refinement/weighting module 226 by scaling a value or score associated with each mapping. In another instance, refinement/weighting module 226 adjusts mappings 116 by adding additional information to the table or by creating secondary mapping tables related to the trademarks through one or more of the attributes, such as owner information.

In this example, other data 105 includes enterprise resource planning (ERP) data 838, products data 840, white papers data 842, financial data 844, and web site data 846. Such other data 105 can be collected or pre-processed using directed web crawlers or Internet bots (not shown), which are software applications that traverse links between web sites and within web sites to extract and process web site data, document data, etc. Such web crawlers or Internet bots can process web sites as a background operation, gradually populating a table or database for later processing using ETL 120 and mapping logic 122.

Other data 105 can also include data behind a company's firewall. In this instance, such data is proprietary and not correlated by correlation system 112; unless an enterprise system within the firewall includes correlation system 112, in which case correlation system 112 can then make use of such data to correlate such proprietary data with other data, such as trademark data. Alternatively, proprietary data can include subscription databases, which include information that can be correlated to trademarks or other documents. In an example, such proprietary data can include an IEEE organization or other organization to which users may subscribe or through which users may purchase documents on a “pay-per-document” basis. In such a case, a relevant document may be related trademarks or patent documents by correlation system 112, but access to such documents and/or its contents may depend on the user's subscription.

FIG. 9 depicts an example of multiple mapping tables 900 illustrating multiple mappings, which mappings can be created by mapping logic 122 and which may be used to relate trademarks to other data. In this example, mapping tables 900 include patent data 104 and mappings between trademarks and patent documents 116. Further, mapping tables 900 include enterprise data 902, which may be proprietary data. As discussed above, if correlation system 112 is used within a company, corporate data within the company may also be correlated to patent documents, trademark documents, and other data. In this example, correlation system 112 may be positioned inside of a corporate firewall for use by employees of the corporation and may not be publicly accessible.

In this example, trademarks have been mapped to international patent classifications as part of the overall mapping, which mappings are depicted in mappings between trademarks and patent documents 116. Such mappings may be created using any of a variety of mapping techniques, such as those discussed below with respect to FIG. 10. Once mapped, existing mappings of patents to revenue through enterprise data 902 can be exploited in conjunction with the mappings between trademarks and patent documents 116 to generate trademark-to-revenue mappings 904, for example.

It should be understood that this is a relatively simple example of a technique for relating existing, available information to trademark data using multiple mappings. Further, though the above-examples were directed to mappings between trademarks and patent documents 116, other mappings may also be generated to relate trademarks to other types of documents or other types of documents to trademarks. Further, such mappings may be refined through other matches, such as through mappings from data collected by Internet bots, etc.

It should be noted that the classification mapping depicted between patent document data 104 and the mappings between trademarks and patent documents 116 represents one possible generalized mapping. Using various techniques, such as those described below with respect to FIG. 10, it is possible to define mappings between trademark text extracted from the description of goods and services of a trademark record and text describing international patent classifications, for example. In such an instance, mapping logic 122 is configured to map the trademark text to such patent classifications, and refinement/weighting module 226 is configured to refine such mappings, such as by removing mappings for service marks to patent classifications other than software classifications.

Once the trademark data is extracted, transformed and loaded into a memory using ETL module 120, mapping logic 122 relates the trademarks (extracted trademark records) to other information, such as patent documents, using one or more of a variety of methods. In an example, mapping logic 122 is configured to apply one or more mapping techniques to define a plurality of mappings between trademarks and patent documents. As discussed above, each mapping represents one or more associations between trademark records and patent documents. It should be understood that ETL module 120 can extract patent data from patent documents, text data from other types of documents, etc. Accordingly, trademark data and patent document data may be extracted and placed into the same table or separate tables. In an embodiment, instead of a “flat file” type of table, it should be understood that the extract data may be stored in a relational database or in another form. However, the table view can be readily understood and is therefore used for illustrative purposes.

FIG. 10 depicts a flow diagram 1000 of one possible embodiment, out of many possible embodiments, of a method of relating trademarks and patent documents, using mapping logic 122 illustrated in FIGS. 1 and 2. In particular, the flow diagram 1000 describes a process of relating trademarks and patent documents over multiple dimensions, after the text data has been scraped or otherwise extracted from at least one trademark record by ETL module 120, using latent semantic analysis (LSA) applied by mapping logic 122. However, as discussed below, the method may be performed using other mapping techniques.

At 1002, each of a plurality of trademark records and each of a plurality of patent documents are profiled to produce trademark and patent sparse matrices, respectively, where each matrix includes rows corresponding to terms within the respective trademark records and includes columns corresponding to the respective documents. In this instance, each trademark record is treated as a document. Further, both the trademark and patent sparse matrices share the same list of unique terms. As discussed above, ETL module 120 may be used to produce such matrices. The matrix of Equation 1 below depicts such a term-document matrix of either a plurality of trademark records or a plurality of patent documents, each unique trademark term (tᵢ) is assigned to a row and each document (dⱼ) is assigned to a column of the matrix. The values (x) within the matrix correspond to a number of hits or instances of a particular term (x) in a particular document (d).

$$[ {t}_{i}^{T} , {d}_{j} ] -> [ \begin{matrix}{x}_{1 , 1} & … & {x}_{1 , n} \\ ⋮ & ⋱ & ⋮ \\ {x}_{m , 1} & … & {x}_{m , n}\end{matrix} ] \qquad ( Equation 1 )$$

Within the matrix of Equation 1, term-document relationships are quantified according to the occurrence of each term within each document. Terms within the term-document matrix need not be “stemmed” because latent semantic analysis (LSA), applied by mapping logic 122, intrinsically identifies relationships between words and their stem forms (e.g., between “computing,” “compute,” and “computer”). As used herein, the term “Latent Semantic Analysis” or “LSA” refers to a technique in natural language processing for analyzing relationships between a set of documents and the terms contained therein by producing a matrix that describes the occurrences of terms within the documents. Terms and their respective stems are intrinsically identified using LSA because LSA relies on the relative frequency of a word and its neighboring content words, assuming that two words are similar if they have similar neighboring content words. Accordingly, stems are inferred from contextual statistics. Thus, mapping logic 122 can operate in conjunction with ETL module 120 to associate each unique term to a row, where the unique term represents each of the forms of a given word.

Continuing to 1004, trademark term vectors for each row of the trademark sparse matrix and patent term vectors for each row of the patent sparse matrix are calculated. In particular, mapping logic 120 applies LSA to calculate the term vectors. Since both matrices have the unique trademark terms, the respective vectors can be compared to identify word matches. In this instance, a row of the matrix represents a vector corresponding to a particular term within, for example, a plurality of trademark records, defining a relation between the particular term and each trademark record or patent document according to Equation 2.

tᵢ^{T}=└x_{i,1} . . . x_{i,n}┘ (Equation 2)

Proceeding to 1006, trademark record vectors for each column of the trademark sparse matrix and patent document vectors (v) for each column of the patent sparse matrix are calculated. In particular, mapping logic 120 uses LSA to reduce the profiled matrix or matrices into document vectors defining each document's relationship to each term in the document space. The respective document vectors relate each of the patent documents and trademark records to the same set of trademark terms. Thus, a column of the matrix depicted in Equation 1 represents a document vector corresponding to a document within the matrix and defining a relationship between the document and each term according to Equation 3.

$${d}_{j} = [ \begin{matrix}{x}_{1 , j} \\ ⋮ \\ {x}_{m , j}\end{matrix} ] \qquad ( Equation 3 )$$

In some examples, it is possible to calculate relevance across a given document space based on the document and term vectors. For example, a dot-product between two term vectors gives a correlation value between the two terms over all of the documents (i.e., a set of documents that include both terms). A dot-product between two document vectors gives a correlation value between the two documents over all of the terms of the document space (i.e., a set of terms contained in both documents). By confining the patent matrix to unique trademark terms, the trademarks and patent documents are related across the unique terms.

In an embodiment, the method advances to 1014, and a dot-product operation is performed on each term vector and each document vector to produce a plurality of mappings between trademarks and patent documents.

Optionally, it is possible to utilize the trademark and patent document sparse matrices to generate concept mappings between trademarks and patent documents. Such a concept mapping can be vector representing a single value term mapped across a document space. When such concept mappings are desirable, blocks 1008-1012 may be included before advancing to block 1014.

Advancing to 1008, the trademark and patent sparse matrices are factored into their respective singular value decompositions. For example, it is possible to factor the matrix depicted in Equation 1 above into a singular value decomposition in the form of M=UΣV*, where U is a m-by-m unitary matrix over the space k, the matrix Σ is an m-by-n diagonal matrix with non-negative real numbers on its diagonal, and V* represents a conjugate transpose of the document vectors (i.e., the column vectors of the matrices). Selecting the largest singular values of concepts (k) and their corresponding singular vectors returns a relevancy ranking across the document space with a minimum error. Further, the resulting “decomposed” term and document vectors can be treated as a “concept space” where the decomposed term vector includes (k) concept entries representing the occurrence of term (xᵢ) in one of the k concepts, and the decomposed document vector gives a relationship between each document (dⱼ) and each concept (kᵢ). The resulting conceptual approximation can be represented by Equation 4.

Xₖ=UₖΣₖVₖ^{T} (Equation 4)

Equation 4 makes it possible to compare documents in a concept space by comparing decomposed document vectors, for example using cosine similarity, to identify clusters of documents. Cosine similarity refers to a technique of determining a cosine angle between two vectors (such as two term vectors or two document vectors), where the angle represents a measure of similarity between the two vectors. An example of document vector singular decomposition is depicted in Equation 5.

dⱼ=UₖΣₖ\hat{d}ⱼ (Equation 5)

Here, the document vector is decomposed using the unitary matrix (U) and the diagonal matrix (Σ). The inverse decomposition is depicted in Equation 6.

\hat{d}ⱼ=Σₖ⁻¹Uₖ^{T}dⱼ (Equation 6)

Alternatively, comparing decomposed term vectors provides a clustering of terms within a concept space. To handle queries, such as query q, terms are first translated into the concept space using the singular value decomposition, as depicted in Equation 7.

\hat{q}=Σₖ⁻¹Uₖ^{T}q (Equation 7)

Once translated, such queries \hat{q} can be applied to the document or term vectors to identify document clusters or term clusters, conceptually, based on the query term.

Returning to the method of FIG. 10, once the matrices are factored (at 1008), the method proceeds to 1010, and a selected trademark term vector is translated to its respective single value decomposition to produce a singular-value term vector. Such translation is similar to that depicted in Equations 6 and 7, except that the term (tᵢ) is used as the query (q).

Moving to 1012, the single value term vector is compared to the single value decomposition of the patent sparse matrix to identify matches, where each identified match corresponds to a conceptual mapping of a trademark to a patent document. In particular, the identified matches represent instances where a trademark record attribute or term overlaps with a patent document attribute or term. Such overlaps may indicate a relationship.

Advancing to 1014, a dot-product operation is performed between each term vector and each document vector to produce a plurality of mappings between trademarks and patent documents and optionally singular value matches. In an example, the singular value matches may be added to the plurality of mappings derived from the dot-product operations.

The method depicted by flow diagram 1000 can be repeated when the trademark data source 106 is updated to map newly added information into the existing matrices. Further, blocks 1008-1012 may be omitted. Additionally, the method 1000 can be repeated, iteratively to identify the plurality of mappings.

It should be understood that LSA represents only one of many different ways of identifying mappings between trademarks and patent documents. Several alternatives or modifications to LSA are described below, which can be substituted for the method of FIG. 10 or which can be used to augment the mappings described in FIG. 10.

One such alternative technique for relating trademarks to patent documents includes a latent Dirichlet allocation (LDA) analysis. As used herein, the term “latent Dirichlet allocation” and “LDA” refer to a generative probabilistic model (i.e., a three-level hierarchical Bayesian model) for collections of discrete data, such as text corpora, in which each item of a collection is modeled as a finite mixture of topics over an underlying set of topics. In LDA, the topic distribution is similar to probabilistic latent semantic analysis except that LDA assumes the topic distribution to have a prior probability distribution representing a priori knowledge or belief about an unknown quantity before any data is observed. In LDA, a document is classified by selecting a distribution over topics and, given this selected distribution, picking a topic of each specific word. Considering the words to be independent of the topics, the words are assigned to particular topics.

In this instance, where LDA is used in lieu of LSA, after block 1002 in FIG. 10, an LDA process may be performed on the profiled data. Once profiled, statistics may be calculated to determine a document model of a probability that a given term is within a set of documents. Such probabilities can be based, in part, on term frequency and inverse document frequency statistics to produce the plurality of mappings.

In an example, Bayesian inference can be used to learn the various distributions (i.e., the sets of topics, their associated word probabilities, the topic (classification) of each word, and the particular topic mixture of each document). One technique includes using a variable Bayes approximation of an a posteriori distribution to learn the various distributions. Alternatively, a learner, such as a neural network or artificial intelligence system, can be trained to learn the various distributions based on a training set, such as a pre-classified set of trademark records that is assembled manually.

In another alternative implementation, a naïve-Bayes classifier can be used to identify such mappings. The naïve-Bayes classifier is a probabilistic classifier based on applying Bayes' theorem with naive independence assumptions, which assume that the presence or absence of a particular term of a class is unrelated to the presence or absence of any other feature. In this instance, again after profiling the data in block 1002, the naïve-Bayes classifier can be used to determine probabilities that particular trademark terms are used in patent documents as discussed below.

Naïve-Bayes classifiers can be trained using a known document space. Abstractly, the probability model for a naïve-Bayes classifier is a conditional model over a dependent class variable for a small number of outcomes or classes, conditioned on several variables. The conditional model can be formulated using Bayes' Theorem under various independence assumptions to define the conditional probability distribution (p) according to Equation 8, for example.

$$p ( C \vert {F}_{1} , … , {F}_{n} ) = \frac{1}{Z} p ( C ) {\prod }_{i = 1}^{n} ( {F}_{i} \vert C ) ) \qquad ( Equation 8 )$$

Such a classifier can be trained, for example, using a subset of patent documents to selectively map patent documents to patent classifications, for example. Since the patent documents are already assigned to patent classifications, the mappings (however flawed) already exist, and the classifier can map the documents to the classifications and learn by comparing the mappings to existing mappings.

In general, naïve-Bayes classifier can decouple the class (category or attribute) conditional feature distributions, which means that the classifier can independently estimate each distribution as a one dimensional distribution, assisting in alleviating problems stemming from expanding, multi-dimensional data sets and allowing the system to scale with the number of features. Under a maximum a posteriori estimator, the naïve-Bayes classifier can arrive at a correct classification when the correct class is more probable than any other class. Thus, a naïve-Bayes classifier can work well for “general proximity” type of mappings, where the class probabilities do not have to be estimated with great specificity and accuracy, but where a general proximity-type of mapping can be relied upon to narrow a search space or to direct or focus further searching.

Though LSA, LDA, and naïve-Bayes techniques are discussed above, in some instances, it may be desirable to apply different mapping strategies for different categories of data. In an embodiment, learner module 230, depicted in FIG. 2, may control mapping technique logic 222 and mapping logic 122 to apply one or more mapping strategies based on the type of information. For example, a first mapping strategy may be used to map trademark owner data to patent assignee data and a second may be used to map text of a trademark description of goods and services to patent classifications from the United States Patent and Trademark Office website. In this example, mapping of owner-to-assignee data can utilize a two-tier “brute force” type of search with reasonable accuracy. In such an approach, company information and individual names can be pre-processed to a set of globally unique identifiers. For example, a company name such as IBM may have multiple different typographical variations, such as “IBM,” “Int'l Bus. Mach s.,” “International Business Machines Corporation,” etc. Each variation can be mapped to the same globally unique identifier (i.e., each variation is assigned to the same globally unique identifier, e.g., IBM=“123”). In this example, to map a trademark owner to a patent assignee, a first search is performed to search the trademark owner data within the set of globally unique identifiers to retrieve its globally unique identifier. Then, a second search is performed on the patent documents, which may already be indexed to include the respective globally unique identifiers, to identify trademark owner to patent assignee mappings. Similarly, where the trademark owner is an individual, a globally unique identifier for the individual's name can be retrieved, and patent documents can be searched based on the globally unique identifier for the individual's name.

In contrast, mapping of text from a description of goods and services of a trademark to a patent document or an international patent classification may utilize more robust mapping algorithms, such as LSA, LDA or naïve-Bayes classifiers as described above. Such classifications can associate semantically related data without requiring exact matches, providing conceptual mapping or category mapping over less-structured portions of the data. In an embodiment, learner module 230 can control mapping logic 122 to apply each of the algorithms to each piece of information and to aggregate the results to determine a probabilistic relationship.

Accordingly, mapping logic 122 selectively applies a desired mapping algorithm based on what data is being mapped. As discussed above, learner module 230 controls mapping technique logic 222 to select one or more mapping techniques 228 and provide selected mapping techniques to mapping logic 122 for mapping the data.

FIG. 11 depicts a flow diagram 1100 of one possible embodiment, out of many possible embodiments, of a method of relating trademarks and patent documents to produce weighted mappings. In an embodiment, learner module 230, depicted in FIG. 2, controls mapping logic 122, mapping technique logic 222, and refinement/weighting module 226 to identify associations between trademark text and patent documents and to weight each association or mapping. In this example, a “brute force” method is described for identifying matches between trademarks and patent documents where each term is searched independently against the patent documents. The matches are then weighted using a term-frequency inverse-document frequency approach.

At 1102, an attribute is selected from a trademark record. The attribute is one of a mark attribute (associated with the mark itself), the description of goods and services attribute, one or more date attributes, an owner attribute, an owner city attribute, an owner state attribute, a type of mark attribute, a trademark classification attribute, or other attributes. In an example, the trademark attributes can be used as the names of fields, such as the fields depicted in the tables 300 and 400 in FIGS. 3 and 4.

Advancing to 1104, a term is selected from the trademark record that is related to the selected attribute. The term can be a word, a phrase, a date, or a numeric value. In an example, a word is selected from the description of goods and services, which word is associated with the description of goods and services attribute of the trademark record. For example, a term or phrase from a term list 406 of the description of goods and services depicted in FIG. 4 may be selected.

Continuing to 1106, patent documents are searched using the selected term to retrieve a set of search results identifying matches between the selected term and one or more patent documents. The search results represent documents that include the selected term. In one instance, a matrix having rows of trademark terms and columns of patent documents is searched for the selected term to identify the term vector, which identifies the associated patent documents.

Moving to 1108, a term frequency value (tf_{i,j}) and an inverse document frequency (idfᵢ) value are calculated for the selected term (tᵢ) relative to each search result (dⱼ). Term frequency can be understood as a statistical value that is the number of occurrences of the considered term (n_{i,j}) normalized over the sum of number of occurrences of all terms in document (n_{k,j}) to provide a measure of importance of the term within the document as depicted in Equation 9.

$${tf}_{i , j} = \frac{{n}_{i , j}}{{\sum }_{k}^{ } {n}_{k , j}} \qquad ( Equation 9 )$$

Inverse document frequency is a measure of general importance of each term over the document space (D), which is obtained by dividing the number of all documents (D) by the number of documents containing the term (tᵢ) and then taking the logarithm of that quotient as depicted in Equation 10.

$${idf}_{i} = log \frac{\vert D \vert}{\vert \{ d \text{:} {t}_{i} ∈ d \} \vert} \qquad ( Equation 10 )$$

The term-frequency inverse-document frequency calculations provide an example of a method of calculating a value that can be used to weight each mapping.

Advancing to 1110, the identified matches and the calculated values are stored as mapping data to relate trademarks to patent documents. Moving to 1112, if there are more terms associated with the selected attribute, the method returns to 1104 where another term is selected and the method is repeated. In some instances, the patent documents and trademark records can be pre-processed so that such data is already stored in a matrix or table.

At 1112, if no more terms are present within the selected attribute, the method advances to 1114 and if there are more attributes within the trademark record, the method returns to 1102 and another attribute is selected.

At 1114, if there are no more attributes, the method advances to 1116 and, if there are more trademark records, a next trademark record is selected at 1118. The method then proceeds to 1102, and an attribute of the next trademark record is selected.

Returning to 1116, if there are no more trademark records, the method advances to 1120, and the mapping data is selectively weighted using one or more ranking algorithms to produce weighted mappings between trademarks and patent documents. In one example, the term frequency can be divided by the document frequency for each individual mapping to generate a weight, which can be assigned to the mapping. In another example, the term frequency and the inverse document frequency can be multiplied to produce a product that represents a weighting for each mapping.

In an embodiment, mappings associated with terms of an attribute are aggregated together, for example by refinement/weighting module 226 illustrated in FIG. 2, to produce an aggregated weighted value mapping a trademark attribute of a particular trademark to a patent document. In another embodiment, refinement/weighting module 226 aggregates mappings associated with each term of the trademark record to produce a singular aggregated weighted mapping for each trademark relative to each patent document.

While the above-example uses a term-frequency inverse-document-frequency technique for weighting mappings derived from a “brute force” type of search, other techniques may also be used. For example, LSA and Naïve-Bayes mapping techniques inherently generate a probability or weighting for each mapping. In such instances, the term-frequency inverse-document-frequency weighting technique can be omitted. Alternatively, the term-frequency inverse-document-frequency can be used to enhance the probabilities to surface related results first when a search term exactly matches a rare term of one of the matrices. In an example, term frequency and inverse document frequency values can be used to scale a value associated with a particularly rare term to ensure the results of the rare term are listed at the top of a set of search results when a query includes the rare term.

In another example, another ranking algorithm can be used, such as a BM25 ranking function, sometimes referred to as the “Okapi BM25,” which was described in an article authored by S. Robertson, H. Zaragoza, and M. Taylor entitled “Simple BM25 Extension to Multiple Weighted Fields,” In Proceedings of the Seventeenth International Conference on Computational Linguistics, pp. 1079-1085 (1988). BM25 identifies meta-data elements in a document and organizes data according to such elements. The BM25 approach can use document statistics to weight a particular document relative to other documents in the space. In an example, the BM25 ranking function ranks documents based on query terms appearing in the document, regardless of the inter-relationship between the query terms, such as their relative proximity. The BM25 ranking function includes several different scoring functions. One example is depicted in Equation 11 below.

$$score ( D , t ) = {\sum }_{i = 1}^{n} ( log \frac{{N}_{d} - n ( {t}_{i} ) + b}{n ( {t}_{i} ) + b} ) \cdot \frac{f ( {t}_{i} , D ) \cdot ( {k}_{1} + 1 )}{f ( {t}_{i} , D ) + {k}_{1} \cdot ( 1 - b + b \cdot \frac{\vert D \vert}{ave\_doc \_length} )} \qquad ( Equation 11 )$$

In Equation 11, the parameters k1 and b are free parameters, which can be chosen to achieve a desired scale. In one example, parameter k1 equals 2.0 and parameter b equals 0.75. Further, variable D represents the document and variable Nd is the total number of documents in the collection. The variable n(tᵢ) represents the number of documents containing the term (tᵢ), and the variable ave_doc_length represents an average document length of the documents in the document collection. In this particular example, the logarithmic term may be negative for terms that appear in more than half of the documents, so the logarithmic function may be replaced for particular implementations or the common terms may need to be treated as “stop words” that are ignored or omitted from such scoring. In an example, the logarithmic term can be replaced with the inverse-document-frequency equation depicted in Equation 10. In either case, refinement/weighting module 226 depicted in FIG. 2 can apply the BM25 ranking function to produce a ranking value that reflects a relationship between the terms and each document in the document space, which can be used to weight the particular mappings.

Once the refinement/weighting module 226 creates the weighted mappings, it may sometimes be desirable to further refine the mappings. For example, other data sources may include information that can be used to verify particular mappings, and/or to supplement the mappings. Further, some mappings may be more reliable than others. For example, a match between trademark owner data and patent assignee data may be more reliable as a relationship than an association defined by a concept mapping. Accordingly, refinement/weighting module 226 is configured to adjust weights for particular mappings to reflect their known reliability. Further, in some instances, other information may be available to confirm or bolster a particular relationship.

Other mappings/rules 232, depicted in FIG. 2, can include mappings related to other data 105, such as whitepapers, manuals, web site information, and other documents. In some instances, such information can include descriptions of a particular product and can include identifying trademark information as well as patent numbers. Such information can be retrieved and analyzed both to supplement existing mappings with additionally related information and to adjust weightings. For example, a copyright page of a particular whitepaper or manual can include references to intellectual property rights, such as patents or trademarks, that are owned by others and that are discussed in the document. Such discussion can be located, extracted and analyzed automatically, using LSA or other types of analysis, to relate such information to the existing data and/or to adjust weights of particular mappings.

Additionally, as mentioned above, learner module 230 (depicted in FIG. 2) can be trained to identify relationships between various pieces of data. While the above examples have focused on mappings between trademarks and patent documents 116, it should be understood that such mappings are discussed for illustrative purposes only, and that correlation system 112 is adapted to map other types of data as well. Further, learner module 230 is configured to generate other mappings/rules 232, which can be used to dynamically relate new information to one or more sets of classifications, such as International Patent Classifications, Industry Classifications, proprietary classifications, and the like. Once the relationships are defined, they too can be stored as other mappings/rules 232 and accessed to produce related data. Further, learner 230 can apply learned rules to dynamically determine associations for new data.

FIG. 12 depicts a flow diagram 1200 of one possible embodiment, out of many possible embodiments, of a method of weighting mappings between trademarks and patent documents based on ancillary data from other data sources. In flow diagram 1200, it is assumed that mappings between trademarks and patent documents 116 were already created, for example by learner module 230 controlling mapping logic 122, using, for example, the methods of FIGS. 10 or 11. Refinement/weighting module 226 processes the mappings according to the method depicted in flow diagram 1200 to weight the mappings.

At 1202, one or more data sources are searched using selected terms of a selected trademark record to retrieve ancillary search results. The data sources can include litigation data, corporate data, enterprise revenue data, financial information, data from web sites, text of whitepapers, etc. The ancillary information can include litigation involving a particular trademark, corporate earnings data identifying products or trademarks, and other information. In some instances, the ancillary information can include a listing or description of intellectual property information within a document.

Advancing 1204, a search result is selected from the retrieved ancillary search results. Continuing to 1206, one or more attributes and dimensions are determined through which the selected search result is related to the selected trademark record. For example, mapping logic 122 can determine the trademark attribute associated with the selected term, such as whether the term is related to the owner data, a trademark registration number, text of the description of goods/services or some other attribute.

Moving to 1208, it is determined whether ancillary search results confirm a mapping between trademarks and patent documents associated with a particular attribute. For example, extracted data from the ancillary search result (such as a litigation information retrieved from a complaint filed with the Federal District Court and retrieved from the Public Access to Courts Electronic Records (PACER)) can be used to verify that a particular trademark is owned by a company, that the trademark is related to a particular product, etc. Alternatively, text from a whitepaper identified through a web-based search may relate a patent to a particular product. Such relationships can be identified using LSA, Naive-Bayes analysis, brute-force, or other mapping algorithms as described above, and resulting scores may be aggregated with existing scores to produce an aggregated score.

Continuing to 1210, if the ancillary search results confirm an existing mapping, the method proceeds to 1212 and a weight/rank of the mapping is adjusted based on the selected search result. For example, if a probabilistic mapping indicated a 75% chance that a particular trademark was related to a particular product sold by a company, which relationship is confirmed based on data extracted from the litigation document, the weight/rank can be adjusted to a probability that is closer to or equal to 100% for the particular mapping. In a different example where the assignee is not listed on the face of the patent, litigation involving the patent may identify the assignee, allowing the system to automatically relate the patent to the assignee.

Continuing to 1214, whether the ancillary data confirmed an existing mapping or not, mappings between trademarks and patent documents are supplemented with mappings between the trademark and the selected search result. Advancing to 1216, if the selected search result is not the last ancillary search result, the method returns to 1204 and a next search result is selected. Otherwise, the method proceeds to 1218 and mappings between trademarks and patent documents (such as mappings of trademarks-to-patent-document 116) and other mappings (such as other mappings/rules 232) are output. As discussed above, learner module 230 can control mapping logic 122 to map other data 105, for example, to a set of classifications, such as International Patent Classifications, which can be stored as other mappings/rules 232 or stored with mappings between trademarks and patent documents 116. In an example, the mappings can be output to a data storage device, such as a hard drive, for storage.

In the example depicted in FIG. 12, rather than querying multiple sources, the query may be applied to an index that is pre-processed. For example, a pre-processed index can be assembled using Internet bot applications, which can perform automated script fetches to fetch and analyze multiple web pages, one at a time, adding them to the index. Conceptual mapping produced as vectors with respect to blocks 508-512 in FIG. 5 may be used to direct the Internet bot application to search particular companies and particular concepts or terms.

### C. The Search System

FIG. 13 depicts an embodiment, in block form, of the search system 118 illustrated in FIG. 1. It should be understood that, once mappings between trademarks and patent documents 116 and other mappings/rules 232 are created, such mappings and rules can be used to assist in searches. In an example, mappings between trademark text and patent classifications can be used to narrow a search scope, limiting search results within a particular subject area, for example. Search system 118, as discussed with respect to FIG. 1, can make use of such mappings to search a document space and to retrieve related information from a different data source.

As discussed above, search system 118 can communicate with user device 110 through network 108. Search system 118 is coupled to network 108 through network interface 1306. Search system 118 includes processing logic 1308, which is coupled to network interface 506 and to memory 1310. Memory 1310 includes interface generator 126 and search logic 124, which are executable by processing logic 1308.

Interface generator 126 includes search interface module 1316 to produce a search interface configured to receive user input and to provide the search interface to user device 110 (or other user devices) through network 108. Additionally, interface generator 126 includes results/visualizations interface module 1318 configured to generate a results interface including search results, which interface may be transmitted to user device 110 through network 108. Both the search interface and the results interface can include user-selectable options, such as buttons, pull-down menus, and/or other options to provide user controls. In some instances, the results interface can include such user-selectable options to allow a user to change the arrangement of displayed information. In one example, the results interface includes search results presented in a list or table and a pull-down menu accessible by a user to change the display from a list to a chart, map, graph, or other graphical rendering of the results. In another example, the results interface can include a graphical map with functionality (such as a pop-up text box) that is accessible by a user when the user positions a pointer (such as a mouse pointer) over a portion of the graphical map. An example of a results interface is depicted in FIG. 17 with a pop-up text box 1716.

Search logic 124 includes query expansion module 1320 configured to perform query expansion on user input. For example, query expansion module 1320 can expand a query to include synonyms, root terms, and other terms derived from the user input to produce an expanded query. In some instances, indexed terms (such as a global unique identifier) may be added to the query based on particular terms within the query to enhance search results.

Search logic 124 further includes query normalization module 1322 to normalize particular query terms. For example, company names can vary from one data source to another. Such names can be normalized to an index so that variations of the query term can be readily retrieved from the different data sources in response to the query. In an example, query normalization logic 1322 is configured to look up a unique global identifier in a global identifier data source (not shown) to retrieve a serial number or other value that can be used to search across multiple data sources. Additionally, query normalization logic 1322 is configured to translate searches into different formats for querying multiple data sources.

In an embodiment, search logic 124 can translate search queries received from user device 110 into multiple formats and forms for searching different data sources. For example, the one or more patent document data sources 104 may use different search structures. In one example, a first patent document data source can be queried using Boolean search logic (including logical operators such as AND, OR, ANDNOT, and the like) and a second patent document data source uses different indicators (such as “+” and “−”) to indicate logical operations. Other data sources, such as other data source 105, may use proprietary query structures. Search logic 124 is configured to translate a received query into formats appropriate for each data source, to send the translated queries to the various data sources, and to process search results into a set of search results.

Search logic 124 also includes search module 1324, which is configured to extract data from search results received in response to the expanded/normalized query and to search mappings between trademarks and patent documents 116 to identify mapping information, which it can then use to retrieve related trademarks from trademark data source 106. Search module 1324 is further configured to produce one or more secondary searches to search for ancillary data (such as financial data, news items, litigation matters, and the like) related to information derived from the set of search results and to utilize retrieved ancillary data to augment the search results.

Search logic 124 further includes data aggregator 1328 to aggregate search results from various data sources into a set of search results. In an embodiment, data aggregator 1328 removes duplicates and combines related search results.

Once aggregated, results ranking module 1326 can process the aggregated search results into a ranked set of search results. In one example, results ranking module 1326 uses a ranking function, such as BM25 or another ranking function, to rank search results. Additionally, ranking module 1326 may apply a selected ranking function to ancillary search results and to retrieved trademark data.

Search logic 124 can include goal-oriented search logic 1330, which is configured to perform a pre-defined type of search. Goal-oriented search logic 1330 includes multiple goal-oriented searches, such as patent invalidity, patent licensing, and the like, which searches are selectable by a user through a user-selectable option within the GUI search interface to initiate a goal-oriented search. Such pre-defined goal-oriented searches are configured to receive at least one user input and to perform a search, applying one or more rules to narrow a scope of a set of search results.

In an illustrative example involving a patent invalidity search, the goal-oriented search logic 1330 will extract patent classification data, priority date information, and non-“stop word” claim terms from a patent identified by a patent number received from a user. Search logic 1330 then performs a search on the key claim terms extracted from the patent (such key terms may be identified by removing connecting terms and stop words and by searching non-stop word terms that appear early in a claim first and then by narrowing the search by selectively adding “rare” terms to the query to refine the results). The search results are automatically limited by date and patent classification, and to exclude patents already cited in the identified patent. The filtered search results are provided in a graphical user interface to a user device, where the search results include a list of un-cited references that are related by key claim terms and classifications and that pre-date the filing date of the identified patent.

When a licensing search is selected, goal-oriented search logic 1330 excludes patents and trademarks that are commonly owned by the owner of a patent being searched. In an example, from a given patent identifier (patent number) received by search module 1324, search module 1324 retrieves an associated patent and extracts classifications from the retrieved patent. Search module 1324 searches mappings between trademarks and patent documents 116 for matches to the extracted classifications from the retrieved patent and for mappings between the patent and one or more trademarks The initial search results of the mappings can be used to narrow a search for possible licensees of a patent, both by excluding those trademarks that are commonly owned by the patent owner and by restricting the set of trademarks that are conceptually related based on the matrix-analysis described above. For the purposes of identifying licensees, it is assumed that the trademarks are used in connection with a good or a service, as opposed to a trade name. Further, it should be understood that ancillary data may be used to refine such mappings to include product information for products or services sold under a given trademark. In particular, such mappings can be refined based on ancillary data extracted from whitepapers and websites, for example, which identify specific products or services under a given trademark. Accordingly, in some instances, searching of mappings between trademarks and patent documents 116 can return related trademark and product information. Finally, such results can be provided as a set of trademarks used in connection with possibly infringing products or services.

Such results, though insufficient to identify infringers for litigation purposes, can limit the number of products to be analyzed, reducing the size of the product landscape. When such goal-oriented searches are applied across a portfolio using goal-oriented search logic 1330, a heat map can be generated that identifies the players and trademarks within a given landscape that may infringe the patent, providing at least starting point for further evaluation.

Though goal-oriented search logic 1330 is described with respect to goals related to intellectual property, other goal-oriented searches may be included to perform particular types of searches. Further, such goal-oriented searches may vary according to the industry.

Search results retrieved by search logic 124 are provided to interface generator 126, which uses results/visualization interface 1318 to produce a GUI including the search results. In some instances, the GUI may present the search results together with ancillary or auxiliary information retrieved through a secondary search of trademark data source 106 using mappings of trademarks to patent classifications 116 to retrieve related trademark data. Such ancillary or auxiliary information may also include data retrieved from other data sources, such as financial data, litigation data, and other data related to the search results by at least one dimension, such as company, individual name, keyword, patent number, trademark number, and the like.

In an example, a user may enter a patent number and submit the data to search system 118. Search system 118 retrieves the patent from patent data source 104, extracts data from the retrieved patent, and uses mappings of trademarks to patent classifications 116 to retrieve trademarks related to one or more patent classifications extracted from the retrieved patent. Search logic 124 can perform a second search of patent data source 104 based on key terms extracted from the retrieved patent, for example to retrieve related patents that were not cited as prior art in the retrieved patent and that have a priority date that predates the priority date of the retrieved patent. Search logic 124 can also perform a search of trademark data source 106 based on the extracted key terms and based on the retrieved mappings to retrieve related trademark information. The retrieved mappings may be used to relate retrieved trademark data to search results from the second search. Interface generator 126 can use results/visualizations interface 1318 to generate a user interface including the search results and related trademark data, which can be sent to user device 110 through network 108.

The above example of augmenting search results by adding related trademark data represents one instance where such mappings of trademark classifications to patent classifications 116 can be used. Further, such mappings can be used to add dimensions to the search results, such that a table of patents and patent publications may be related to a set of trademarks through such mappings. Further, though the search system 118 is described as mapping trademarks to patents, search system 118 is not so limited. Instead, search system 118 can retrieve and relate data from different sources using one or more mappings to define the associations.

It should be understood that modules 1316, 1318, 1320, 1322, 1324, 1326, 1328, and 1330 are depicted for illustrative purposes only. Not all of the modules may be needed in every implementation. Further, in some instances, modules may be combined and other modules may be added.

FIG. 14 depicts a flow diagram of an embodiment of a method of searching one or more data sources using the search system 118 illustrated in FIGS. 1 and 13. At 1402, a user input is received at a computing system from a user device, where the user input includes at least one query term. In an example, the query term can include one or more keywords. In another example, the query term can include a document identifier, such as a patent number, a patent publication number, a title, or some other identifier. The user input may be received in response to user submission of query terms through a search interface produced by search interface generator 1316 of interface generator 126, which can be transmitted to user device 110 through network 108. Search interface includes at least one text input box to receive a user input and includes a submit button selectable by a user to submit the user input to search system 118. Received text input can be extracted by search logic 124 and used to query one or more data sources.

Advancing to 1404, query expansion and/or normalization are performed on the at least one query term to produce a query. In an example, query expansion module 1320 and query normalization module 1322, depicted in FIG. 13, are used to process the query terms. Query expansion may include adding one or more terms and/or reducing terms to their semantic roots and expanding the root term so that variants of a term are also located. Further, query expansion can include adding one or more semantic equivalents (i.e., synonyms) to a query to expand the scope of the query. Normalization of the query can include removing common terms (such as “the,” “in,” and other common terms. Additionally, normalization can include standardization of terms, such as company names. In one particular instance, company names and other indexed terms can be reduced to a numeric value, which can function as a global identifier that spans multiple data sources to simplify a term search across different data sources, which may represent the same company in different ways.

Continuing to 1406, at least one first data source is searched using the produced query. In an embodiment, search module 1324 depicted in FIG. 13 transmits one or more produced queries, related to the user input, to at least one data source, such as patent data source 104. In an example, the one or more produced queries may be applied to multiple data sources, including databases, web-sites, and other search engines.

Proceeding to 1408, search results are received from the at least one data source based on the produced query. Search module 1324 may receive the search results.

Moving to 1410, one or more attributes are extracted from the received search results using, for example, search module 1324. In an example, the one or more attributes include keywords, document identifier information, ownership data, and other information. In an example, search module 1324 includes an ETL module (such as ETL module 120 in FIG. 1) to extract the attributes.

Proceeding to 1412, at least one second data source is searched automatically using the extracted one or more attributes and using mappings of trademark to patent classifications to identify at least one trademark related to the received search results. Search module 1324 can automatically search at least one second source, such as mappings between trademarks and patent documents 116, to identify a trademark related to a patent classification within a particular patent of the set of search results. Further, keyword searches may be performed on trademark data source 106 and on other data sources 105, such as financial databases, litigation databases, and other data sources. Search results from such ancillary data sources can be used to refine the results.

Advancing to 1414, the previously received search results are augmented with auxiliary data (i.e., data from the search of the second data source) received from the at least one second data source. The results of the keyword searches can be related to the previously received search results, for example, using the data aggregator 1328. For example, set of search results (in table or list form) including patents and patent publications that are related to a particular user query may be supplemented with related trademarks, related financial data, related litigation data, and other information. Data aggregator 1328 can combine search results with the ancillary data to augment (supplement) the search results.

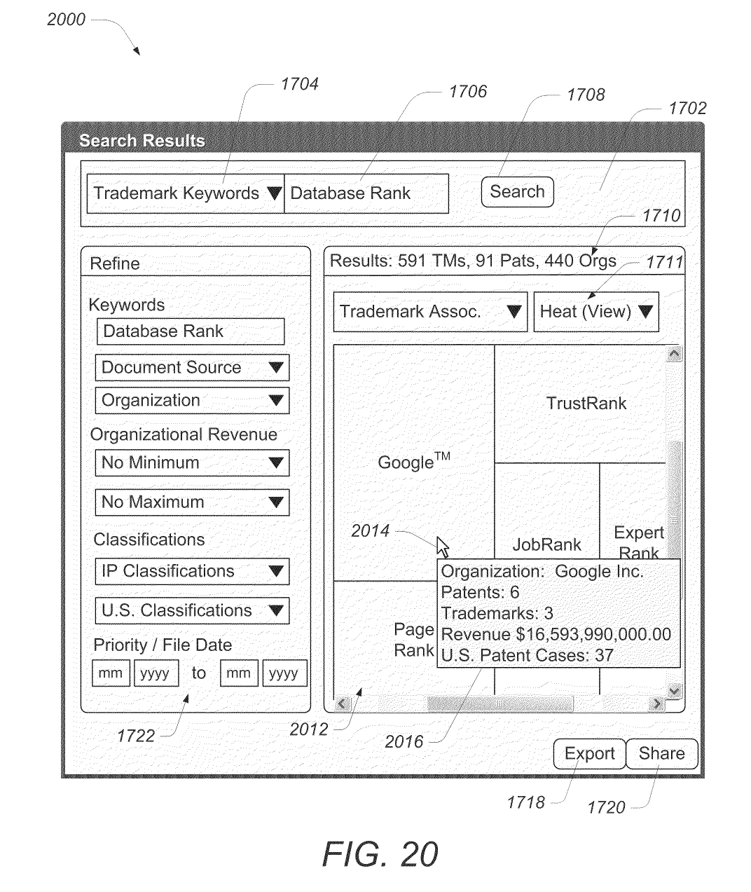

Moving to 1416, an interface is generated that includes the augmented search results. Data aggregator 1328 can pass the augmented search results to interface generator 128, which uses results/visualizations interface 1318 to produce the interface. The interface may be provided to a user device, such as user device 110 in FIG. 13, through a network connection. The interface can include one or more user selectable elements, such as buttons, menus or tabs, for interacting with the augmented search results. In a particular example, positioning a pointer (such as a mouse pointer) over a particular search result causes the auxiliary data to be displayed, as shown in the graphical user interface depicted in FIGS. 17 and 20.

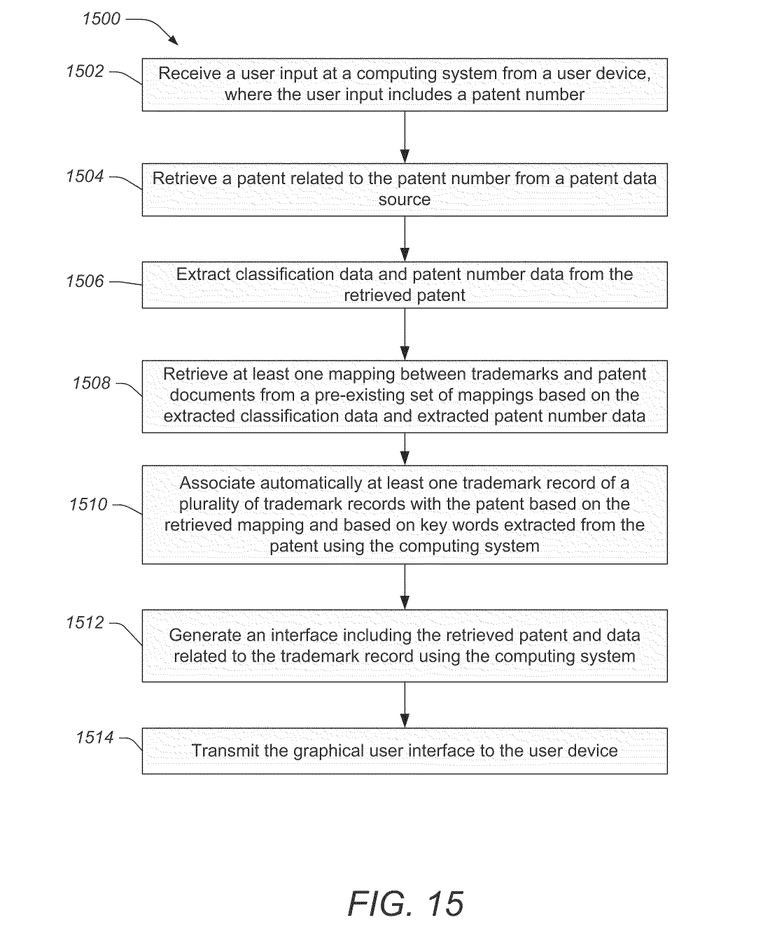

FIG. 15 depicts a flow diagram of another embodiment of a method of automatically retrieving trademarks using the search system 118 illustrated in FIGS. 1 and 13. In this example, search module 1320 retrieves trademark information in response to receiving a patent number. A goal-oriented search, such as a pre-defined search to identify a list of trademarks related by subject matter to a given patent, may retrieve trademarks based on a patent number.

At 1502, a user input is received at a computing system from a user device, where the user input includes a patent number. The user input may also include a goal-oriented search selection, such as an invalidity search, a patent licensee search, etc. Alternatively, the user input can include one or more keywords. As discussed above, interface generator 126, depicted in FIGS. 1 and 13, can use search interface 1318 to produce an interface including a text input, a submit button, and a drop-down menu including a list of search types, such as keyword search, patent invalidity search, patent licensing search, and other goal-oriented search items. The interface is sent to user device 110 through network 108. A user can enter a patent number into the text input, select a goal-oriented search from a drop-down menu, and select the submit button to transmit the goal-oriented query to search system 118. Search module 1324 can extract patent number and utilize goal-oriented search logic 1330 to perform a goal-oriented search.

Advancing to 1504, the computing system automatically retrieves a patent related to the patent number from a patent data source. Search module 1324 can retrieve the patent from patent data source 104, for example. In an embodiment, search module 124 of search system 118 can retrieve a set of search results related to the user input, such as for example, the patent identified by the patent number.

Continuing to 1506, classification data is extracted from the retrieved patent (or set of search results) using, for example, an ETL module (such as ETL module 120 in FIG. 1) within search module 1324 in FIG. 13. The classification data can include United States Patent and Trademark Office patent classification data, international patent classification data, or other classification data. In an embodiment where the patent data source 104 is proprietary, the classification data can also include proprietary classifications.

Proceeding to 1508, at least one mapping between trademarks and patent documents is retrieved from a pre-existing set of mappings between trademarks and patent documents (such as mappings between trademarks and patent documents 116) based on the extracted patent classifications. The mappings can include conceptual mappings between text of trademarks descriptions of goods and services and text of United States or international trademark classifications, for example. Search module 1324 can retrieve such mappings based on the extracted patent classifications.

Moving to 1510, at least one trademark record of a plurality of trademark records is associated with the retrieved patent based on the retrieved mappings and based on keywords extracted from the patent using the computing system. In an example, search module 1324 provides the retrieved patent and data related to the identified mappings to data aggregator 1328, which combines the search results into an augmented set of search results. In an embodiment, the keywords may be derived from the user query, and not from the patents. In another example, two different queries may be applied to the trademark data source 106 (one using the user query and one using extracted keywords). The results of the two different queries may produce two different sets of search results, and an overlap between the two sets of search results may be related to the patent. Search module 1324 may identify such overlap and provide overlapping data items to data aggregator 1328. Further, search module 1324 may search other data 105 to retrieve additional or ancillary information based on extracted keywords, patent classification data, and/or retrieved trademark mappings.

Continuing to 1512, an interface is generated that includes the retrieved patent and data related to the trademark record using the computing system. Data aggregator 1328 can provide the augmented search results to interface generator 126, which uses results/visualizations interface 1318 to produce the interface. In an example, the generated interface includes the retrieved patent as well as related information, such as financial data associated with the company that owns the patent, trademark information associated with the subject matter of the patent, and other information. Proceeding to 1514, the generated interface is transmitted to the user device. An example of interfaces including augmented search results are provided in FIGS. 17-20.

In an example, search module 1324 searches pre-determined mappings between trademarks and patent documents 116 for mappings that relate the retrieved patent to one or more trademarks. In another example, where the search is a goal-oriented search, search module 1324 can extract data from the patent, search for related patents in a patent data source, and search the mappings between trademarks and patent documents for matches and/or mappings based on identified related patents. In this instance, search module 1324 may use goal-oriented search logic 1330 restrict (refine) the search results based on date, owner, or other information, depending on the particular goal-oriented search.

For refined search results and/or for goal-oriented searching, additional steps may be included. For example, search results, such as the trademark data identified in block 1508, may be refined by utilizing owner/assignee data from the patent and from the plurality of trademark records to identify commonly owned trademarks, which can then be associated with patent results for the particular companies using data aggregator 1328. Further, the computing system can search date, location, people, and company information to further narrow the set of search results before generating the graphical user interface. In such an instance, the data included within the interface may include fewer results than if the refining steps were not applied.

In a particular example, goal-oriented searches can include an infringement search, which can be initiated by a user through a single click. In an example, an infringement search can be initiated by a user by entering a patent number and selecting an infringement search. In this example, search system 118 searches for similar patent documents to identify companies in the same space and searches trademark mappings for trademarks that are in the same product space and that are owned by other companies. In some instances, identified trademarks can identify the product being sold that might infringe claims of the patent, though further investigation would be required by a skilled practitioner. However, such goal-oriented searches can narrow the scope of the search results significantly, making the practitioner's job in identifying potential infringing products easier. In another example, such goal-oriented searching can be applied to product/portfolio management, making it possible to review possible licensing opportunities for a given patent.

In another example, where the mappings include trademark to product mappings, which identify particular products being sold in connection with a given trademark, a “one-click” goal-oriented search can be used to identify products that possibly infringe a particular patent. Alternatively, a product name could be provided, and search system 118 can identify patents and/or trademarks that the product may infringe, making it possible to generate a report indicating a product exposure, such as what products lack adequate protection as well as what patents or trademarks a given product might infringe.

Other goal-oriented searches can also be included. For example, given revenue data, a goal-oriented search can identify companies with assets within a range of the given revenue data. For example, a search can be performed using a revenue range from $100 million to $10 billion, which search can return a list of companies and their associated intellectual property.

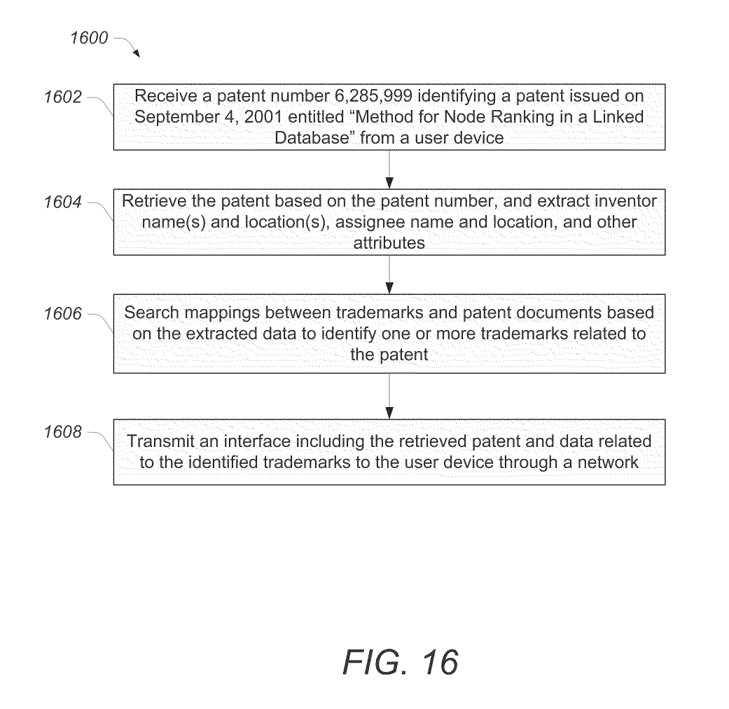

FIG. 16 depicts a flow diagram 1600 of a specific example of a method of searching using the search system 118 illustrated in FIG. 13 to retrieve search results and related data. In this example, the patent and the trademark are related to a particular technology (ranking of web pages), but the relationship would not be apparent without either a priori knowledge of the relationship or through secondary sources. In particular, the trademark is owned by a corporate entity, which has one of the inventors of the patent as its co-founder. However, the patent is assigned to a University and not to the company. Thus, they are not commonly owned and provide few direct associations that would lead a user to identify both documents in a single search.

However, using search system 118 and mappings between trademarks and patent documents 116 depicted in FIGS. 1 and 13 (and other mappings/rules 232 depicted in FIG. 2 for example), both documents are not only identified but can be related to one another by data aggregator 1328. Turning to the specific example, at 1602, a U.S. Pat. No. (6,285,999) is received from a user device. The patent number identifies a patent issued on Sep. 4, 2001 entitled “Method for Node Ranking in a Linked Database.”

Advancing to 1604, the patent is retrieved based on the patent number and inventor names and locations, assignee name and location, and other attributes are extracted from the retrieved patent. For example, an ETL within search module 1320 extracts the information. In some instances, such data may be retrieved directly, such as from a pre-processed index without retrieving the patent.

In this particular example, the patent is assigned to “The Board of Trustees of the Leland Stanford Junior University” of Stanford, Calif., and Lawrence Page of Stanford Calif. is listed as the sole inventor. Additionally, U.S. Patent Classifications include “707/5; 707/7; 707/E17.097; 707/E17.108; 715/206; 715/207; 715/230; 715/256” and International Patent Classifications include “G06F 17/30 (2006 Jan. 1); G06F 017/30.” Other attributes can include the number of claims and other information derived from the patent.

Continuing to 1606, mappings between trademarks and patent documents are searched based on the extracted data to identify one or more trademarks related to the patent. In this instance, the identified one or more trademarks include registration U.S. Pat. No. 2,820,024 issued to Google Technology Inc. for the mark PAGERANK based on strength of word matches between description of goods and services, matches between inventor name of the patent and corporate officer name (i.e., Larry Page is the patent inventor and co-founder of Google Technology Inc.), and ancillary data (such as Wikipedia entry linking PAGERANK and the patent number). Though the patent is assigned to “The Board of Trustees of the Leland Stanford Junior University” and the trademark is assigned to Google, Inc., the mapping logic 122 is configured to relate the trademark and the patent, allowing the related documents to be located in the same search based on the ancillary information. Such information can also be confirmed and adjusted (promoted) based on the ancillary data. For example, web site data derived from a WIKI-type web site describing the PAGERANK algorithm may confirm the relatedness of the patent and the trademarks and web-accessed articles indicating that Google Technology Inc. is a licensee of the patent.

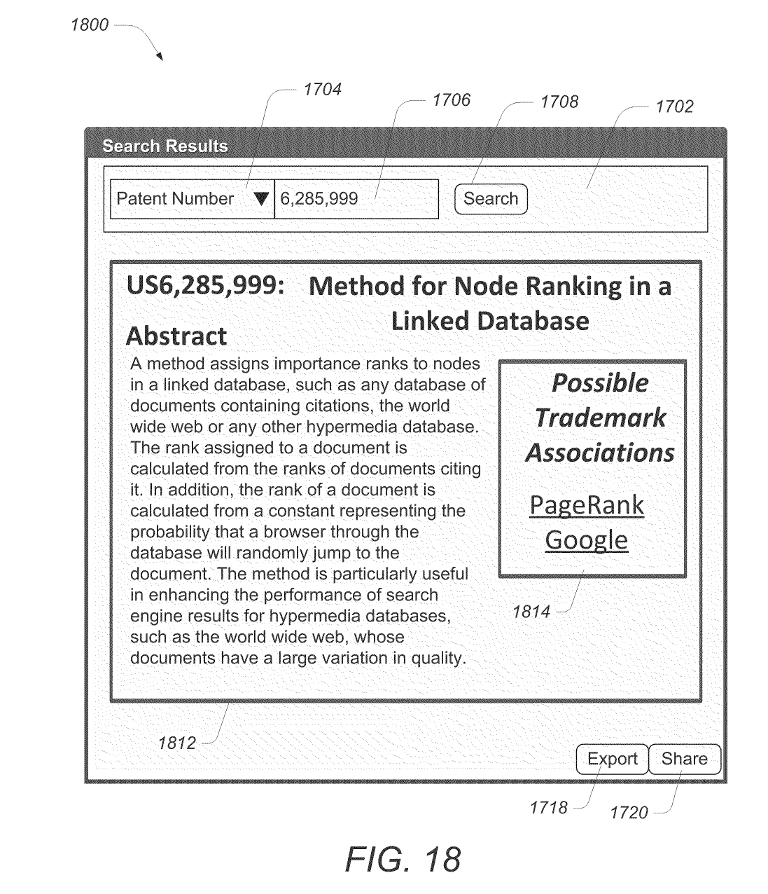

Proceeding to 1608, an interface including the retrieved patent and data related to the identified trademarks is transmitted to the user device through a network. An example of possible resulting search results interfaces are depicted in FIGS. 17 and 18.

FIG. 17 depicts an embodiment of an interface 1700 generated by interface generator 126 of search system 118 illustrated in FIGS. 1 and 13 that includes data related to search results. Interface 1700 includes a heat map 1712 of a set of patent search results for the term “Pagerank” and a pop-up text box 1716 depicting augmented information including trademark data associated with the search term and related to the company “Google Inc.” based on one or more mappings. As used herein, the term “heat map” refers to a graphical representation of a number of documents in a particular category. In this instance, the heat map reflects the number of documents associated with each organization (“category”). Thus, in this particular document space, Microsoft Corporation has the most documents within the set of search results derived by searching one or more data sources using the keyword “Pagerank.”

Interface 1700 includes search portion 1702 including pull-down menu 1704 to select between different types of searches, such as between a “Patent Keywords” search, a “Patent Number” search, a “Trademark Keywords” search, a “Trademark Number” search, and other types of searches. Search portion 1702 further includes a text box 1706 to receive user input and a submit button 1708 to submit a query.

Interface 1700 further includes results portion 1710 indicating 42 patent results, 12 trademark results, and 16 different organizations. Results portion 1710 further includes user-selectable elements, such as pull-down menu 1711 to allow a user to alter a menu selection that causes the display (context) of the data to change. Results portion 1710 includes heat map 1712 because “Heat (View)” is currently selected through pull-down menu 1711. However, other views are selectable through the pull-down menu 1711, such as a table view (which may include a list of search results organized by company, for example), a geographical map view relating the search results to a geographical map, an industry view relating the search results to industries, an organization (group) view relating the search results to some other category, and other views of the search results.

Heat map 1712 includes ancillary data, in addition to patent search results retrieved through a patent keyword search for the term “Pagerank.” Such ancillary data is accessible through pop-up text box 1716 when pointer 1714 is positioned over a related portion of heat map 1712. In this instance, pop-up text box 1716 includes revenue data, a number of patents, a number of patent cases (total), and a number of trademarks related to the term “Pagerank.” In this case, Google owns three trademarks for the term PAGERANK. Such ancillary data may be accessed either by clicking on the portion of the heat map 1712 or by utilizing one of the pull-down menus 1711.

Interface 1700 also includes an export button 1718 that is accessible to export data from the set of search results to a text file, such as a tab or comma delimited file that can be imported into Microsoft® Excel® spreadsheet or opened in a word processing application for further processing. Additionally, interface 1700 includes a share button 1720 that is accessible by a user to share the search results with another user, through a web-based interface or through email, for example.

Interface 1700 also includes a refinement portion 1722 that includes multiple user-selectable elements, including text inputs and pull-down menus to refine the set of search results, for example, through additional keywords, document source selections, organization selections, revenue ranges, classifications, or date ranges. In one instance, selection of an item from one of the pull-down menus within refinement portion 1722 produces a negation that remove search results from the search results based on the selection.

As mentioned above, mappings between trademarks and patent documents provide one possible example of a readily understandable set of mappings of unrelated or tangentially related documents. However, it should be understood that learner module 230 can control mapping logic 122 to generate relationship data to relate documents from all kinds of different sources, for example, through a set of pre-defined classifications or subject-matter categories, such as Industry classifications, International Patent Classifications, and the like. By training learner module 230 to generate such mappings, new data (such as data extracted from a user manual, a white paper, or a website, can be provided to learner module 230 and mapped to the existing classifications dynamically, without relying on pre-existing mappings. In this instance, International Patent Classifications, for example, can be used as a “Rosetta Stone” to relate search results between different data sources, across domains, between databases, between websites, and between various otherwise unrelated sets of search results.

Further, established mappings and those confirmed through user feedback can be stored for later use. In an example, interface 1700, within refinement portion 1722, can include feedback buttons to promote or demote various associations either within a particular search or globally. Such social voting could be used to refine mappings so that, over time, learner module 232 receives dynamic feedback from users to further refine its mapping logic and the existing mappings, such as mappings between trademarks and patent documents 116.

FIG. 18 depicts another embodiment of an interface 1800 generated by interface generator 126 of search system 118 illustrated in FIGS. 1 and 13 that includes data related to search results. Interface 1800 includes search portion 1702 including pull-down menu 1704 to select between different types of searches, such as between a “Patent Keywords” search, a “Patent Number” search, a “Trademark Keywords” search, a “Trademark Number” search, and other types of searches. In this instance, the Patent Number search is selected and text box 1706 includes a patent number.

Interface 1800 further includes results portion 1812, which includes the patent number, title, and abstract text. Additionally, results portion 1812 displays a list of possible trademark associations 1814, including “PageRank” and “Google” trademarks. Thus, search system 118 can identify a listing of trademarks based on a patent number input.

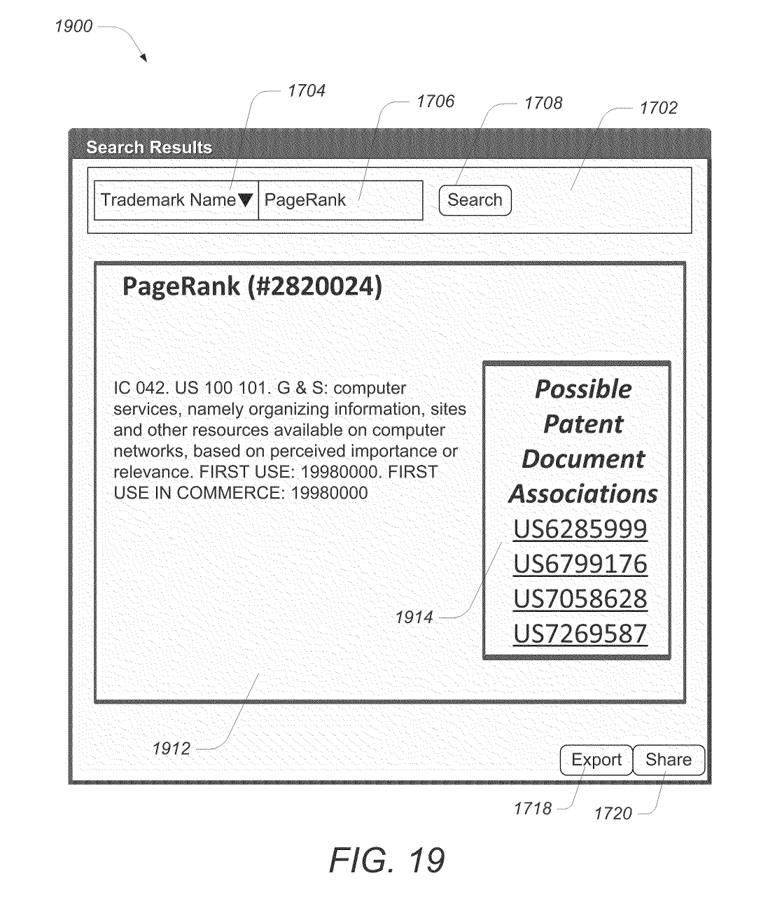

FIG. 19 depicts still another embodiment of an interface 1900 generated by interface generator 126 of search system 118 illustrated in FIGS. 1 and 13 that includes data related to search results. Interface 1900 shows a “Trademark Name” search based on the selected menu item 1704 and the text box 706 shows the term “PageRank.”

Interface 1900 further includes results portion 1912, which includes the trademark name, the trademark number, and the associated description of goods and services scraped from the trademark record. In this example, the description of goods and services is not modified for display by ETL processing. Results portion 1912 further includes a list of possible patent document associations 1914, including U.S. Pat. Nos. 6,285,999; 6,799,176; 7,058,628; and 7,269,587. Thus, search system 118 can identify a listing of patents based on a trademark text input. Similarly, a trademark number input can be used to generate a listing of possibly associated patent documents. It should be understood that, though only issued patents are shown in the list of possible patent document associations 1914, the list can also include published patent applications.

FIG. 20 depicts yet another embodiment of an interface 2000 generated by interface generator 126 of search system 118 illustrated in FIGS. 1 and 13 that includes data related to search results. In this example, pull-down menu 1704 is configured to search trademark keywords and text input 1706 includes the phrase “Database Rank.” In this instance, interface 2000 includes results portion 1710 indicating 591 trademarks, 91 patents, and 440 organizations were related to the search results for the phrase. Results portion 1710 includes heat map 2012 because “Heat (View)” is currently selected through pull-down menu 1711. However, unlike heat map 1712 depicted in FIG. 17, the data is organized by trademark rather than by company.

Heat map 1712 includes ancillary data, in addition to patent search results retrieved through a trademark keyword search for the phrase “Database Rank.” Such ancillary data is accessible through pop-up text box 2016 when pointer 2014 is positioned over a related portion of heat map 2012. In this instance, pop-up text box 2016 includes revenue data, a number of patents, a number of patent cases (total), and a number of trademarks related to the organization “Google Inc,” which owns the trademark. In this case, Google owns three trademarks related to the terms database and rank. Such ancillary data may be accessed either by clicking on the portion of the heat map 2012 or by utilizing one of the pull-down menus 2011.

In conjunction with the systems and methods described above with respect to FIGS. 1-20, systems and methods are disclosed that relate documents from different data sources to produce mappings and/or a learner module trained to produce such mappings dynamically. One example includes mappings between trademarks and patent documents. In this example, by correlating trademarks to patent documents, a plurality of mappings between trademarks and patent documents are created, which provide a framework for retrieving trademarks in relation to patent searches. Once created, a search engine can utilize the mappings to augment search results and/or to retrieve trademarks that are related to particular patents. Further, once trained, a learner module 230 can be used to dynamically map new data into the existing mappings or classifications.

Many additional modifications and variations may be made in the techniques and structures described and illustrated herein without departing from the spirit and scope of the present invention. For example, particular modules or systems may be combined, and/or other functions may be broken out as separate systems or modules to perform the various operations. Accordingly, the present disclosure should be clearly understood to be limited only by the scope of the claims and the equivalents thereof.

We claim:

1. A computer-readable medium embodying instructions that, when executed by at least one processor, cause a computing system to perform operations comprising:
automatically identifying one or more associations between a trademark record and a patent document; and
storing the one or more associations as mappings between trademarks and patent documents.

2. The computer-readable medium of claim 1, wherein automatically defining one or more associations comprises identifying words matches between selected words of a description of goods and services of the trademark record and terms within the patent document.

3. The computer-readable medium of claim 2, wherein identifying word matches comprises using latent semantic analysis to determine occurrences of words from the description of goods and services within text of the patent document.

4. The computer-readable medium of claim 1, further embodying instructions that, when executed by at least one processor, cause the computing system to perform operations further comprising:
calculating a weight for each of the one or more associations; and
storing the weight with each of the one or more associations.

5. The computer-readable medium of claim 1, further embodying instructions that, when executed by at least one processor, cause the computing system to perform operations further comprising extracting data from each trademark record of a plurality of trademark records.

6. The computer-readable medium of claim 5, wherein automatically defining one or more associations between a trademark record and a patent document comprises automatically defining one or more associations between each trademark record and one or more patent documents of a plurality of patent documents.

7. A method of associating trademarks and patent documents, the method comprising:
extracting data from a trademark record of a plurality of trademark records using an extract-transform-load module of a correlation system;
automatically defining one or more associations between the trademark record and patent documents of a plurality of patent documents based on the extracted data using mapping logic of the correlation system; and
storing the defined one or more associations as mappings within a plurality of mappings between trademark records and patent documents in a computer-readable memory.

8. The method of claim 7, wherein before storing the defined one or more associations, the method further comprises calculating a weight for each of the one or more associations.

9. The method of claim 8, wherein calculating the weight comprises:
determining a term frequency and an inverse document frequency for each word of the trademark record; and
calculating the weight for each association as a function of the term frequency and the inverse document frequency.

10. The method of claim 8, wherein the weight represents a numerical value indicating a relevance of an association based on a word match between a word from the trademark record and corresponding words from each of the patent documents.

11. The method of claim 7, further comprising:
receiving a query from a user device;
retrieving search results from one or more data sources based on the query;
using the plurality of mappings between trademark records and patent documents to retrieve related information.

12. The method of claim 11, further comprising:
generating an interface including the search results and the related information; and
transmitting the interface to the user device.

13. The method of claim 11, wherein the query comprises a patent search, wherein the search results include one or more patents, and wherein the related information comprises data from at least one trademark record associated with a respective at least one patent document of the search results.

14. The method of claim 11, wherein the query comprises a trademark search, wherein the search results include one or more trademark records, and wherein the related information comprises data from at least one patent document associated with a respective at least one trademark record of the search results.

15. A method of relating trademarks and patent documents, the method comprising:
automatically identifying associations between trademark records of a plurality of trademark records and documents of a plurality of documents using mapping logic of a correlation system; and
storing the identified associations within a plurality of mappings in a memory, each mapping including one or more associations between a trademark record and a document.

16. The method of claim 15, wherein automatically identifying one or more associations comprises:
extracting data including words and numerical values from each trademark record of the plurality of trademark records;
determining a data type associated with each word and each numerical value;
selecting a mapping technique from a plurality of mapping techniques based on the determined data type; and
applying the selected mapping technique using the mapping logic to automatically identify the one or more associations.

17. The method of claim 16, further comprising:
selecting a first mapping technique when the extracted data is a word corresponding to a name of an individual or of a company; and
selecting a second mapping technique when the extracted data is a word extracted from a description of goods and services of a trademark record.

18. The computer-readable medium of claim 17, wherein the plurality of mapping techniques includes at least one of latent semantic analysis, Naive-Bayes classification, and brute-force analysis.

19. The method of claim 15, wherein the plurality of documents comprise issued patents and published patent applications.

20. The method of claim 19, further comprising:
receiving, at a search system having access to the memory, a patent document number from a user device;
retrieving search results related to the patent number using a pre-defined goal-oriented query;
retrieving trademark data related to one or more of the search results based on the plurality of mappings; and
transmitting a graphical user interface including the search results and including the retrieved trademark data to the user device.

21. The method of claim 20, wherein the pre-defined goal-oriented query comprises one of a patent invalidity search to identify potentially invalidating prior art references and a patent licensing search to identify potential licensees of a patent.

22. The method of claim 19, further comprising:
receiving, at a search system having access to the memory, a keyword query related to the plurality of trademark records from a user device;
retrieving trademark records related to the keyword query;
retrieving patent documents related to the retrieved trademark records based on the plurality of mappings; and
transmitting an interface including the retrieved trademark records and data related to the retrieved patent documents to the user device.

23. The method of claim 15, further comprising:
automatically extracting text from a trademark document of the plurality of trademark records; and
selectively searching portions of each document of the plurality of documents using the extracted text to identify matches.
